(19) United States
(12) Patent Application Publication
(10) Pub. No.: US 2026/0259709 A1
(43) Pub. Date: Sep. 3, 2026

(54) KNOWLEDGE AUGMENTATION IN SUPERVISED INSTRUCTION FINE-TUNING OF GENERATIVE MODELS

(71) Applicant: Oracle International Corporation, Redwood Shores, CA (US)

(72) Inventors: Duc Thien Nguyen, Melbourne (AU); Tuyen Quang Pham, Springvale (AU); Prashan Madumal, Melbourne (AU); Omid Mohamad Nezami, Sydney (AU); Mohammad Mahdi Kazemi Moghaddam, Sydney (AU); Thanh Tien Vu, Herston (AU); Yakupitiyage Don Thanuja Samodhye Dharmasiri, Melbourne (AU); Thanh Long Duong, Glen Waverley (AU)

(73) Assignee: Oracle International Corporation, Redwood Shores, CA (US)

(21) Appl. No.: 19/529,887

(22) Filed: Feb. 4, 2026

Related U.S. Application Data
(60) Provisional application No. 63/764,723, filed on Feb. 28, 2025.

(51) Int. Cl. G06F 8/35; G06N 3/042

(52) U.S. Cl. CPC G06F 8/35; G06N 3/042

(57) ABSTRACT

Techniques are disclosed herein for knowledge augmentation in supervised instruction fine-tuning of generative models such as LLMs. The techniques include using a generative model to create augmented training examples to fine-tune a pre-trained generative model. The process begins with original training examples, where each example has a coding prompt and a corresponding gold code solution. Using a documentation dataset containing API or component references, the generative model generates new, enriched training examples having a prompt that instructs the pre-trained generative model to describe the relevant components in addition to performing the code task, and a solution that includes the component descriptions and their roles followed by the original gold code solution. The pre-trained model is then fine-tuned using a combined set of original and augmented training examples, resulting in a more accurate and capable final model.

### CROSS-REFERENCE TO RELATED APPLICATION

The present application is a non-provisional application of and claims the benefit and priority under 35 U.S.C. 119(e) of U.S. Provisional Application No. 63/764,723, filed on Feb. 28, 2025, the entire contents of which is incorporated herein by reference in its entirety for all purposes.

### FIELD

The present disclosure relates generally to Artificial Intelligence (AI)-assisted development tools, and more particularly, to API knowledge augmentation (e.g., API knowledge augmentation) in supervised instruction fine-tuning of generative models such as Large Language Models (LLMs).

### BACKGROUND

Generative model-based coding assistants are advanced software tools that utilize generative models such as Large Language Models (LLMs) to assist developers in writing, editing, and understanding code. These assistants leverage the capabilities of generative models like OpenAI's GPT series, Code Llama, and other specialized LLMs trained on vast data sets of source code and technical documentation. By analyzing the context of a developer's current work, such as the structure of existing code, comments, and coding patterns, these tools can provide real-time suggestions for code completions, generate new code snippets, and even offer explanations for complex code logic. Their primary goal is to enhance productivity, reduce errors, and streamline the coding process by acting as an AI-powered pair programmer.

One of the core functionalities of generative model-based coding assistants is their ability to understand and adapt to different programming languages and frameworks. They are trained on multilingual code repositories, including open-source platforms like GitHub, allowing them to recognize syntax, libraries, and best practices across languages such as Python, Java, JavaScript, C++, and more. Additionally, these tools integrate into popular integrated development environments (IDEs) like Visual Studio Code, IntelliJ IDEA, and PyCharm, providing seamless support directly within the developer's workspace. By understanding the broader context of a project, such as its dependencies and architecture, generative model-based coding assistants can suggest solutions tailored to the specific needs of the codebase.

Beyond code generation and completion, these assistants offer several other features that boost their utility. They can debug code by identifying syntax errors, logic flaws, or runtime issues and suggest fixes in real-time. Many also provide natural language explanations for code, making them invaluable for developers learning a new language or framework. Advanced tools can even generate tests, documentation, or boilerplate code, significantly reducing the time developers spend on repetitive tasks. In addition, some generative model-based coding assistants are capable of handling queries written in plain language, enabling developers to ask questions like “How do I implement a binary search in Python?” and receive precise, context-aware responses.

The rise of generative model-based coding assistants represents a transformative shift in the software development landscape. By automating routine code tasks and providing intelligent suggestions, these tools allow developers to focus on higher-level problem-solving and innovation. However, they also raise new challenges, such as ensuring the accuracy and quality the code suggestions, completions, and generation capabilities. Despite these challenges, the adoption of generative model-based coding assistants is rapidly growing, with tools like GitHub Copilot, Code Llama, and other similar tools, making coding more accessible, efficient, and collaborative for developers of all experience levels.

### BRIEF SUMMARY

Machine learning techniques are disclosed herein (e.g., a computer implemented method, a system, non-transitory computer-readable medium storing code or instructions executable by one or more processors) for knowledge augmentation in supervised instruction fine-tuning of generative models such as LLMs. The techniques focus on a fine-tuning approach that injects knowledge such as API knowledge into generative models through two primary data synthesis techniques:
Reference Question-Answering: Structured Q&A pairs are generated from documentation, covering, for example, method names, descriptions, and valid parameters.
Augmentation in Code Generation: To enhance knowledge awareness such as API awareness in real-world code, code generation prompts are augmented with additional instructions describing programming language knowledge such as API methods. The corresponding ground-truth solutions may be augmented using a Retrieval-Augmented Generation (RAG) process to provide precise knowledge descriptions.

In some embodiments, a computer-implemented method includes accessing training examples, wherein each of the training examples comprises: (i) a prompt including a code task to be performed using a target programming language, and (ii) a completion including a gold code solution associated with performance of the code task; accessing a documentation dataset comprising references for components of the target programming language; generating, by a generative model based on the training examples and the documentation dataset, augmented training examples, wherein each of the augmented training examples comprises: (i) an augmented prompt including instructions to generate a description of one or more of the components of the target programming language and the code task to be performed using the target programming language, and (ii) an augmented completion including: the one or more components of the target programming language, role descriptions of the one or more components that are extracted directly from the documentation dataset, and the gold code solution; and fine-tuning a pre-trained machine learning model with at least the augmented training examples to generate a fine-tuned machine learning model.

In some embodiments, the computer-implemented method further comprises generating, by a generative model and/or a structured programmatic process based on the documentation dataset, synthetic training examples, wherein each of the synthetic training examples comprises: (i) a synthetic prompt including a question associated with one or more of the components of the target programming language, and (ii) a synthetic completion including an answer to the question that is extracted directly from the documentation dataset; where the fine-tuning the pre-trained machine learning model is performed with at least the augmented training examples and the synthetic training examples to generate the fine-tuned machine learning model.

In some embodiments, the target programming language is a low-resource programming language, the documentation dataset is an API documentation dataset, and the components of the low-resource programming language include one or more script types, one or more modules, one or more methods, one or more entry points, or any combination thereof.

In some embodiments, the computer-implemented method further comprises, for each training example in the training examples: (i) extracting a subset of components from the completion of the training example using a rule-based process; (ii) extracting documentation related to the extracted subset of components from the documentation dataset; and (iii) filtering, by a generative model, the extracted subset of components and the extracted documentation to extract the one or more components of the target programming language and the role descriptions of the one or more components.

In some embodiments, the computer-implemented method further comprises, for each training example in the training examples: (i) extracting a subset of components from the completion of the training example using a rule-based process, wherein the subset of components comprises script types, modules, methods, and entry points of the target programming language; (ii) extracting API documentation related to the script types, the modules, the methods, and the entry points from the documentation dataset; and (iii) filtering, by a generative model, the extracted subset of components and the extracted documentation to select relevant script types, modules, methods, entry points, or any combination thereof from the script types, the modules, the methods, and the entry points and the role descriptions of the selected relevant script types, the selected relevant modules, the selected relevant methods, the selected relevant entry points, or the selected any combination thereof, where each of the augmented training examples comprises: (i) an augmented prompt including the instructions to generate, before generating a predicted code solution to the code task, a description of the selected relevant script types, the selected relevant modules, the selected relevant methods, the selected relevant entry points, or the selected any combination thereof and the code task to be performed using the target programming language, and (ii) an augmented completion including: the selected relevant script types, the selected relevant modules, the selected relevant methods, the selected relevant entry points, or the selected any combination thereof, role descriptions of the selected relevant script types, the selected relevant modules, the selected relevant methods, the selected relevant entry points, or the selected any combination thereof, and the gold code solution.

In some embodiments, the computer-implemented method further comprises, for each training example in the training examples: (i) extracting a subset of components from the completion of the training example using a rule-based process, wherein the subset of components comprises script types, modules, methods, and entry points of the target programming language; (ii) extracting API documentation related to the script types, the modules, the methods, and the entry points from the documentation dataset; and (iii) filtering, by a generative model, the extracted subset of components and the extracted documentation to select one or more relevant methods, from the methods and the role descriptions of the selected one or more relevant modules, where each of the augmented training examples comprises: (i) an augmented prompt including the instructions to generate, before generating a predicted code solution to the code task, a description of the selected one or more relevant modules and the code task to be performed using the target programming language, and (ii) an augmented completion including: the selected one or more relevant modules, role descriptions of the selected one or more relevant modules, and the gold code solution.

In some embodiments, the computer-implemented method further comprises: receiving an input from a user, the input comprising a natural language component; converting the input into a prompt, wherein the prompt comprises an instruction, a code snippet associated with the natural language component, and an utterance associated with the natural language component, and wherein the utterance includes a request to perform the code task using or based on the target programming language; transmitting the prompt to the fine-tuned machine learning model; receiving, from the fine-tuned machine learning model, a predicted code solution corresponding to execution of the code task based at least in part on the prompt; and providing the predicted code solution to the user.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example code tool, according to various embodiments.

FIG. 2 depicts a simplified diagram for an example generative AI code agent system, according to various embodiments.

FIG. 3 depicts a simplified diagram for an example generative AI code agent, according to various embodiments.

FIG. 4 depicts a simplified block diagram for training, testing, and producing a code model, according to various embodiments.

FIG. 5 depicts a simplified block diagram for a knowledge augmentation framework, according to various embodiments.

FIG. 6 is a flowchart illustrating a process for generating a fine-tuning data set including augmented and/or synthetic training examples to fine-tune a machine learning model for one or more code tasks, according to various embodiments.

FIG. 7 is a block diagram illustrating one pattern for implementing a cloud infrastructure as a service system, according to various embodiments.

FIG. 8 is a block diagram illustrating another pattern for implementing a cloud infrastructure as a service system, according to various embodiments.

FIG. 9 is a block diagram illustrating another pattern for implementing a cloud infrastructure as a service system, according to various embodiments.

FIG. 10 is a block diagram illustrating another pattern for implementing a cloud infrastructure as a service system, according to various embodiments.

FIG. 11 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

The present disclosure relates to systems and methods for assisting software developers in code-related tasks such as code generation, completion, explanation, documentation or unit test generation through the use of advanced artificial intelligence technologies, specifically generative models such as Large Language Models (LLMs). Generative AI-based coding assistants represent a significant advancement in the field of software development, providing developers with real-time support by generating context-aware code suggestions, completions, and explanations. These tools leverage the capabilities of machine learning models trained on extensive data sets of source code, programming documentation, and technical resources to act as intelligent, AI-powered pair programmers. By analyzing the context of a developer's current work, such as the structure of existing code, comments, and programming patterns, such systems aim to enhance productivity, reduce errors, improve accuracy, and streamline the software development process.

Traditional code editing tools and integrated development environments (IDEs) offer limited support for code completion and debugging, relying on predefined rules and syntax libraries. In contrast, generative AI-based coding assistants are dynamic and adaptive, capable of understanding and generating code across multiple programming languages and frameworks. These systems are conventionally trained on multilingual repositories, including open-source codebases, enabling them to provide comprehensive support for programming languages such as Python, Java, JavaScript, C++, and others. Furthermore, their integration into popular IDEs, such as Visual Studio Code, IntelliJ IDEA, and PyCharm, allows them to operate within the developer's workflow, providing intelligent recommendations based on the broader context of a project, including its dependencies, architecture, and coding standards.

Despite their numerous advantages, the integration of generative AI-based coding assistants into the software development process raises important considerations, including ensuring the quality and accuracy of the generated code. However, improving and optimizing the accuracy of generative models, such as LLMs, in assisting software developers presents several challenges. One major challenge is ensuring the quality and correctness of the code generated, as even small inaccuracies in syntax or logic can lead to errors or vulnerabilities in the software. LLMs often rely on vast data sets of publicly available code, which may include outdated, inefficient, or insecure coding practices, making it difficult to guarantee consistent, high-quality outputs. Additionally, understanding the nuanced context of a developer's codebase-such as project-specific architecture, dependencies, or coding standards-requires fine-tuning the model to handle diverse and complex scenarios effectively. Another challenge lies in balancing the model's computational efficiency with its accuracy, as larger models with higher capabilities often require significant processing power, which can limit their practicality for real-time use in IDEs. Furthermore, addressing intellectual property concerns and ensuring compliance with open-source licensing when training models on publicly available code repositories adds another layer of complexity. These challenges collectively highlight the need for continuous innovation in model training, fine-tuning, and validation to ensure generative AI-based coding assistants can provide reliable, accurate, and contextually appropriate assistance to developers.

To enhance the focus and performance of generic base LLMs on coding tasks such as code generation, one step is supervised fine-tuning (SFT) using instruction data curated for the task. In the SFT process, positive data may be utilized, where each data point has an input prompt comprised of an instruction and a code generation solution. However, even with identical input prompts, there are multiple approaches to writing code for a given programming language. This challenge is particularly prominent in training generative models to handle low-resource programming languages. Low-resource programming languages, as used herein, refers to programming languages where there is limited data, technical tools, and linguistic resources available for training and developing effective generative models on various code tasks such as code generation, code documentation, code explanation, and test code generation. More specifically, for widely used programming languages like Python, Java, JavaScript and SQL, LLM based code generation shows promising results, and presents a viable solution to be used as a coding assistant for developers. Notably, the latest state-of-the-art (SOTA) open-source models, such as Llama 3.1, exhibit impressive performance in generating code for widely used programming languages. However, their performance is subpar when it comes to less commonly used and lesser-known programming languages. This challenge is akin to the difficulties LLMs encounter in generating an understanding rare human languages. It is, in some respects, a more complex issue because some programming languages are designed for specialized use cases, in contrast to the general nature of human languages.

For example, SuiteScript is a low-resource programming language built on top of NetSuite and based on JavaScript. It specializes in automating business processes using the SuiteScript APIs. Scripts can access and manipulate business records and user information (e.g., field changes, form submissions, pre-read and prewrite operations, web requests). At the time of filing this application, SuiteScript has two major versions: 1.0 and 2.x, with significant differences in functionality, syntax, and API references (e.g., most function APIs in 1.0 are invalid in 2.x). Current open-source models exhibit major weaknesses in generating SuiteScript code snippets for specific user tasks, because:
Due to SuiteScript being based on JavaScript, LLMs often generate generic JavaScript code instead of SuiteScript-specific syntax.
LLMs tend to generate SuiteScript 1.0 code when the user requests 2.x code, likely because the models have less knowledge of SuiteScript 2.x API references.
LLMs frequently miss generating correct JDoc comment blocks and other necessary components for the proper functionality of a SuiteScript code snippet.
LLMs can erroneously produce incorrect structures (e.g., wrong entry points) due to insufficient knowledge and semantic understanding of SuiteScript 2.x.
LLMs exhibit API Hallucination in low resource languages such SuiteScript.

More specifically with respect to API Hallucination, a major challenge in deploying generative models such as LLMs for low-resource programming languages is their lack of API knowledge. The two primary issues observed are API hallucination, where the model generates non-existent API methods, and API inaccuracy, where the model produces incorrect syntax for existing methods. These errors are particularly common for low-frequency APIs due to the scarcity of publicly available code examples, leading to insufficient training data and suboptimal model performance.

To address these challenges and others, the techniques described herein implement a fine-tuning approach that injects knowledge such as API knowledge into generative models such as LLMs through two primary data synthesis techniques:
Reference Question-Answering: Structured Q&A pairs are generated from documentation, covering, for example, method names, descriptions, and valid parameters.
Augmentation in Code Generation: To enhance knowledge awareness such as API awareness in real-world code, code generation prompts are augmented with additional instructions describing programming language knowledge such as API methods. The corresponding ground-truth solutions may be augmented using a Retrieval-Augmented Generation (RAG) process to provide precise knowledge descriptions.

These techniques aim to improve model accuracy in various code-related tasks involving low-resource programming languages such as SuiteScript by reducing hallucinations and ensuring correctness (e.g., API correctness). It should be understood, however, that the framework and techniques described herein can be extended more generally to include code-related tasks involving any other programming languages such as SQL/Java. The framework and techniques described work by augmenting generative model finetuning with additional knowledge from corresponding knowledge source(s) such as API documents of the target programming language. The framework and techniques are specifically demonstrated in SuiteScript language, but the framework and techniques can be easily extended to any other languages, especially other low-resource programming languages, with other knowledge from other sources.

More specifically, in the context of SuiteScript and API methods, the framework and techniques effectively mitigate the API hallucination problem by incorporating API knowledge into the model training data. This strategic augmentation empowers the fine-tuned model with a strong API knowledge base in the target programming language, enabling it to develop a deeper understanding of the language's syntax, semantics, and API usage patterns. As a result, the fine-tuned model exhibits a significantly reduced API hallucination rate, which is an important issue in code generation tasks where the model may introduce non-existent or incorrect API calls. By minimizing this issue, the techniques described herein ensure that the generated code is more accurate, reliable, and maintainable. The augmented API knowledge enables the model to produce high-quality output for code-related tasks, such as code completion, code generation, and code summarization. This improvement in output quality is a direct consequence of the model's enhanced understanding of the programming language and its associated APIs, which is achieved through the techniques of incorporating API knowledge into the model training data.

In an exemplary embodiment, a computer-implemented method is provided that includes accessing training examples, wherein each of the training examples comprises: (i) a prompt including a code task to be performed using a target programming language, and (ii) a completion including a gold code solution associated with performance of the code task; accessing a documentation dataset comprising references for components of the target programming language; generating, by a generative model based on the training examples and the documentation dataset, augmented training examples, wherein each of the augmented training examples comprises: (i) an augmented prompt including instructions to generate a description of one or more of the components of the target programming language and the code task to be performed using the target programming language, and (ii) an augmented completion including: the one or more components of the target programming language, role descriptions of the one or more components that are extracted directly from the documentation dataset, and the gold code solution; and fine-tuning a pre-trained machine learning model with at least the augmented training examples to generate a fine-tuned machine learning model.

In some instances, the computer-implemented method further comprises generating, by a generative model and/or a structured programmatic process based on the documentation dataset, synthetic training examples, wherein each of the synthetic training examples comprises: (i) a synthetic prompt including a question associated with one or more of the components of the target programming language, and (ii) a synthetic completion including an answer to the question that is extracted directly from the documentation dataset; where the fine-tuning the pre-trained machine learning model is performed with at least the augmented training examples and the synthetic training examples to generate the fine-tuned machine learning model.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action is based at least in part on at least a part of the something.

### Overview of Agents and Code Assistant Framework

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing an utterance such as request: “Explain the purpose of this code snippet”, to the agent, and the agent responding with a natural language response to the utterance based on processing of a prompt including the user's natural language utterance.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may process by executing a code task such as code generation, completion, explanation, documentation or unit test generation. The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

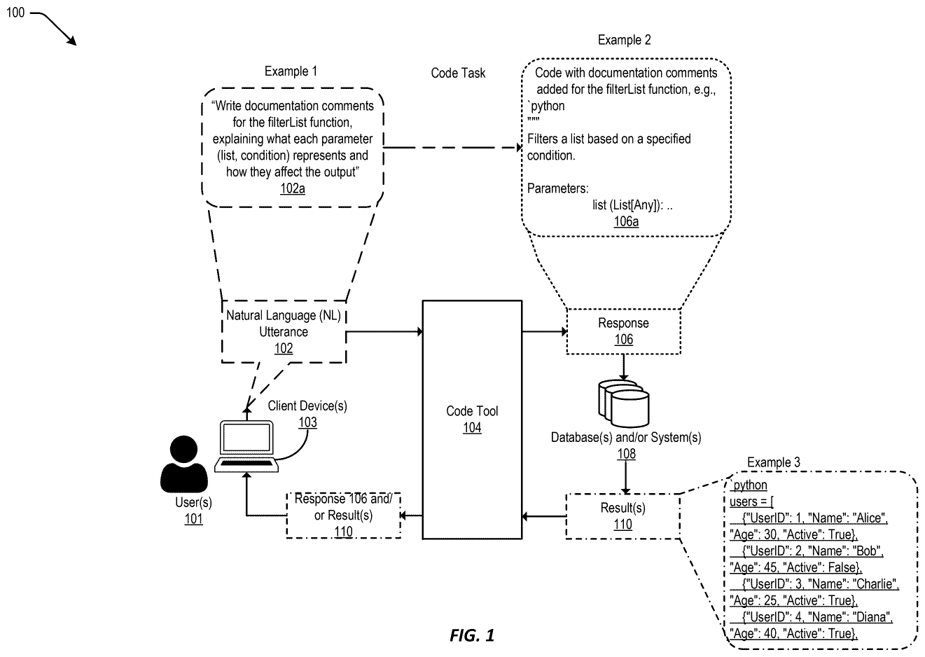

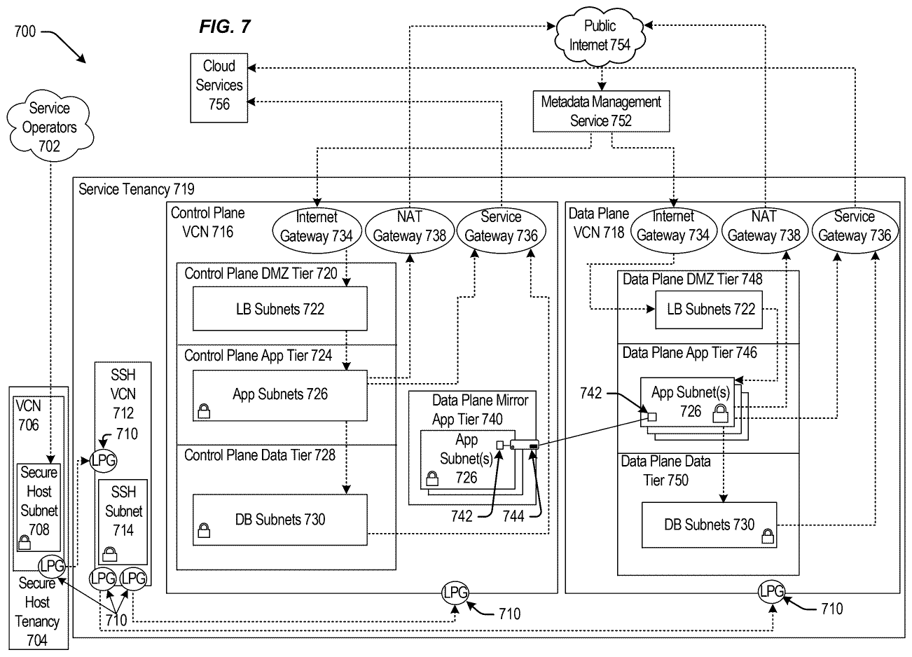

FIG. 1 depicts a simplified diagram of an environment 100 incorporating an exemplary code tool, according to various embodiments. Environment 100 includes a code tool 104 that enables users 101 to send a response 102 (e.g., a request for code generation, completion, explanation, etc.), receive a response 106 (e.g., unit test code, code with documentation added, code review summary, detailed explanation of the code in natural language, and the like) and/or a result 110 of executing code related to a response 106 (e.g., a unit test code, which is then executed on test or production system). As shown in FIG. 1, the code tool 104 is configured to generate a response 106 and/or one or more result(s) 110 based on the provided natural language utterance 102, however other examples may implement tasks in addition to or alternative to code tasks (e.g., codebase checking, extraction of key information, and other codebase related tasks). The code tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 7-11) and the code tool can be implemented as part of the IaaS by leveraging the scalable computing resources and storage capabilities provided by the IaaS provider to process and manage large volumes of data and complex computations. This setup can allow the code tool 104 to deliver real-time, responsive interactions while ensure high availability, security, and performance scalability to meet varying demand levels. The code tool 104 can be embodied or implemented in various physical systems or devices, such as in a computer, a mobile phone, a watch, an appliance, a vehicle, and the like. For the purposes of examples herein, the code tool 104 generates and accepts utterances related to Java code, but it should be understood that the techniques described herein are not limited to Java and the code tool 104 can be configured as any other code tool capable of generating response and/or results using other programming languages (e.g., SQL, Ruby, Web Assembly, Python, R, C++, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the code tool 104 via client device(s) 103. The client devices(s) 103 can be configured to communicate with the code tool 104, provide the natural language utterance 102 to the code tool 104 and receive outputs from the code tool 104. In some implementations, the natural language utterance 102 can be in speech form, which may be converted to text form and provided to the code tool 104. As an example, a natural language utterance 102 such as 102a “Write documentation comments for the filterList function, explaining what each parameter (list, condition) represents and how they affect the output” can be spoken by the user 101 and the code tool 104 may be configured as a standalone or via a plug-in, or make use of some other audio-to-text translator, configured to translate the audio into text for further processing.

The code tool 104 may be or may make use of one or more generative artificial intelligence models such as LLMs configured to generate a natural language response 106 (e.g., 106a) based on the natural language utterance 102. The code tool 104 may receive a prompt including the natural language utterance 102 to generate a response 106 that it is relevant to the user 101 preferences. In some implementations, the user 101 and/or client device 103 generate a prompt including the natural language utterance 102 before providing the prompt to the code tool 104. In other implementations, the code tool 104 receives the natural language utterance 102 and generates the prompt itself, e.g., populates slots of a prompt template, before providing the prompt to a trained generative artificial intelligence model.

The code tool 104 executes a code task and responds to the natural language utterance 102 (as in example 1 depicted in FIG. 1). The code tool 104 may consider code (e.g., a code snippet in the prompt or code retrieved from within a codebase) to generate the response 106. In some implementations, the response 106 is provided to the user(s) in addition to or without running the piece of code (e.g., code snippet) on the database(s) and/or system(s) 108. Additionally or alternatively, the code tool 104 may provide the response 106 to the user(s) via some other means such as an email communication, SMS message, or other type of notification receivable on one or more other computing devices. In some implementations, the response 106 (as in examples 2 depicted in FIG. 1) may be executed on database(s) and/or system(s) 108 to obtain a result 110. As a non-limiting example, a result 110 can be a filtered list of students above the age of 18 based on a received or generated piece of code (e.g., code snippet). The result(s) 110 can be provided back to the user 101 by the code tool 104. In some instances, the result(s) 110 are reported back to the user 101 as raw output. In other instances, the result(s) 110 are reported back to the user 101 as part of the natural language response (e.g., a summary) generated by the one or more generative artificial intelligence models in response to the natural language utterance 102. In other instances, the result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the result(s) 110 through the client device(s) 103.

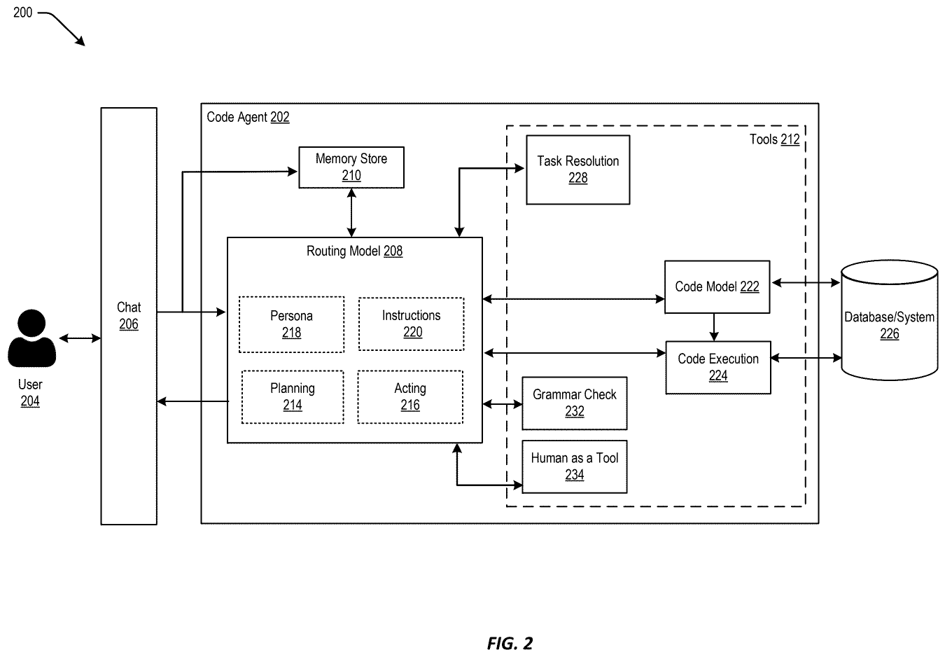

FIG. 2 is a simplified block diagram of a code agent system 200 according to certain embodiments, code agent system 200 is a computing system that can be implemented in software only, hardware only, firmware only, or any combination of hardware, software, and/or firmware. The code agent system 200 can execute various code tasks in response to natural language questions to help users complete their code tasks by leveraging the power of generative artificial intelligence such as LLMs. In addition to their code task capabilities (e.g., code generation, completion, explanation, documentation or unit test generation), generative artificial intelligence can generate natural language responses as part of a conversation with the user. The purpose of the code agent system 200 is to enable users to complete their code tasks with the least amount of effort. This may include the code agent system 200 interpreting user requests in natural language, reviewing code, determining the code task to be performed, performing the code task, and generating a response and even causing the execution of the code. In certain embodiments, the code agent system 200 can be used to implement one or more tools related to code tasks (e.g., code tool 104 as described with respect to FIG. 1). The code agent system 200 can include a code agent 202 capable of performing one or more code tasks.

A user 204 can participate in a chat 206 (also described herein as a conversation or an interaction) with the code agent 202. The user 204 may interact with the chat 206 via a user interface such as a graphical user interface or conversational user interface. As an example, the user 204 may provide a user input to the code agent 202 via a user interface element such as a chat window. The chat 206 can include one or more inputs from the user 204 and one or more responses from the code agent 202. The chat 206 may correspond to one or more chat sessions between the user 204 and the code agent 202. During the chat 206, the user 204 provides a natural language utterance that can be processed by the code agent 202. The natural language utterance can include a question related to a code task.

One or more user inputs provided by the user 204 via the chat 206 are provided to the code agent 202. Included in the code agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the code task operations such as in-context examples, APIs (e.g., API to a code repository), external knowledge, and the like. The tools 212 can include functions, APIs, and trained machine learning models that can be used by the code agent 202 to interact with external systems (e.g., database or system 226, external knowledge bases) and/or generate responses.

The routing model 208 may be or may make use of one or more generative artificial intelligence models such as LLMs. The routing model 208 can include a planning 214 component and an acting 216 component (i.e., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the code agent 202 may be LLM-based tools configured to receive a prompt and generate a response and/or result based at least in part on the prompt. As an example, the tools 212 can include an LLM-based code model 222 that generates response based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example | |
|---|---|
| Persona | Example Description |
| Junior | A user having limited to no experience in writing code that |
| Developer | requires assistance in writing and optimizing code. |
| Expert | A user with several years of experience writing code. |
| Developer | |
| Business | A user with strong context about the needs of a company |
| Analyst | and wants quick data insights without deep programming or |
| | coding knowledge. |
| Data | A user focused on extracting and analyzing data efficiently. |
| Scientist | |

Instructions 220 describe the knowledge bases and tools available to the code agent 202. Instructions 220 can be included in a prompt for LLM-based tools and may guide a tool to generate a response relevant to preferences of user 204. Additionally, or alternatively, the prompt can include context, in-context examples, instructions, a user question, snippets of code, or any combination thereof. In some examples, context may include contextual information related to the user 204 and/or chat 206 history and may be retrieved from the memory store 210 by the routing model 208. The prompt may further include code snippets corresponding to a codebase.

The routing model 208 may provide the generated prompt to a tool from the tools 212 selected by planning 214. As an example, the code model 222 receives a prompt provided by the routing model 208 and generates response based on the prompt. The code model 222 can be trained to execute code tasks and generate responses to help the user 204 complete code tasks. In some examples, the responses generated by the code model 222 are returned to the user 204 via the chat 206. Additionally, or alternatively, the generated responses are provided to a code execution 224 tool that is configured to execute code on the database or system 226. Code execution 224 may receive a result from the database or system 226 and provide the result to the routing model 208. The routing model 208 may provide the result to the user 204 via the chat 206. In some implementations, the routing model 208 may identify an error in the result or determine the response and/or result does not correspond to user 204 needs and generate new plan using planning 214 to correct the error or generate a new response and/or result.

Additional examples of tools include, but are not limited to, task resolution 228, grammar check 232, and human as a tool 234. Task resolution 228 may be configured to check for and/or fix any errors with execution of code task and/or within a response. The code agent 202 may use task resolution 228 before or after a response is generated by the code model 222. Schema linking 230 may be configured to identify proper references to schema values (e.g., tables, columns, condition values) based on schema information and query patterns. Also included in the tools 212 is a grammar check 232 that can review grammar of generated responses. Tools 212 can also include human as a tool 234. The code agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The code agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 202 as received by the routing model 208 (i.e., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a code component (e.g., a snippet of generated code). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the code agent 202 may provide a visualization of the generated result through a plot, table, graph, and the like, via the chat 206. As a particular example, the code agent 202 can use the task resolution 228 tool to determine code task in a natural language utterance (which is an example of NL utterance 102 with respect to FIG. 1) provided by the user 204 and then generate response using the code model 222 based on the code task. The response may be provided to the user 201 via the chat 202 as generated by the code model 222. In some implementations, the routing model 208 may generate a natural language response containing the code task execution and/or results and provide the natural language response to the user 201 via the chat 202.

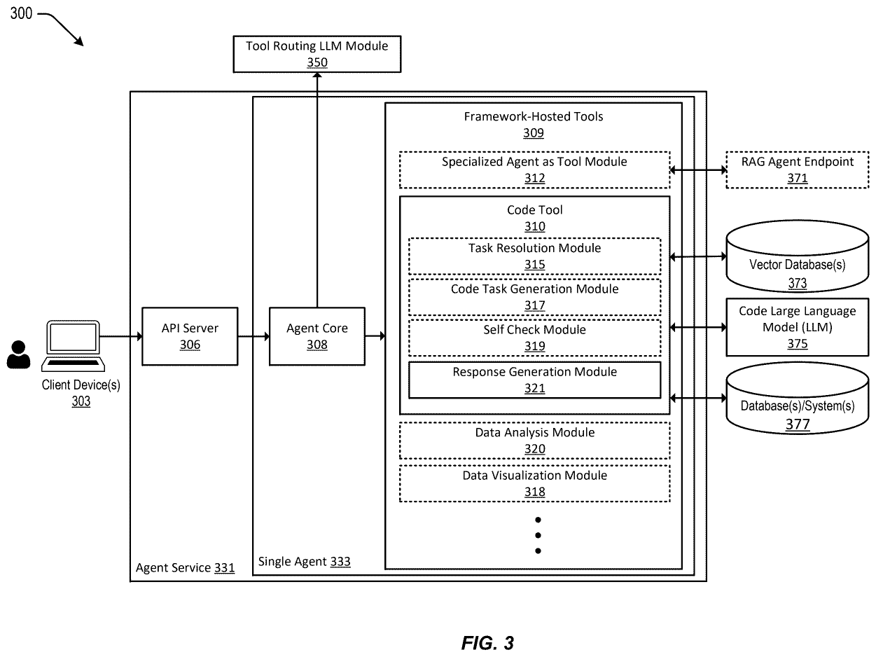

FIG. 3 depicts a simplified diagram 300 for an example generative AI code agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) code task resolution, task execution such as code generation, and/or execution. By way of a non-limiting example, in various code task use cases using unique software packages (e.g., IDE plugins for IntelliJ, VSCode, OCI Code Editor and other IDEs, etc.), a single or multiple interfaces may generate code task response using input from one or more users. The agent core 308 may access a tool routing LLM module 350 in order to identify, select, utilize, and/or train one or more LLM(s) that may suitably execute a code task described in an utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, code, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the framework hosted tools 309 is a code tool 310, which is an example of the code model 218 with respect to FIG. 2. The code tool 310 includes, without limitation, modules 315, 317, 319, and 321. Task resolution module 315 may function to receive input from the client device(s) 303 requesting the code tool 310 check the task request or code for any errors (e.g., syntax errors, sematic errors, etc.) and fix the errors (or recommend a fix). The agent core 308 may provide explanations to the client device(s) 303 about each fix performed. The explanations may be provided in natural language. In some examples, the code tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of code agent 202 with respect to FIG. 2) may return can include syntax errors and semantic errors. The task resolution module 315 may reference one or more vector database(s) 373 to obtain and/or store various code tasks and descriptions thereof.

Also included in the code tool 310 is a code task generation module 317. The code task generation module 317 may take the utterance received from the client device(s) 303 and perform one or more code tasks such as generate code. To do this, the code tool 310 may access one or more generative artificial intelligence models such as LLMs (e.g., SQL LLM 375) that may have been trained on performing the one or more code tasks. An LLM may receive the utterance from the code tool 310 and may perform the one or more code tasks. The code task generation module 317 may then pass the task output from the LLM to one or more additional modules. For example, the task code generation module 317 may pass the generated code returned from the LLM to a response generation module 321. The response generation module 321 may append the generated code (optionally along with information related to the utterance) and return the response to the client device(s) 303. In addition, or alternatively, the response generation module 321 may pass the task output and/or the response to one or more database(s) or system(s) 377 to execute the code related to the utterance. The code tool 310 may utilize a self-check module 319, which may function with any one or more of the other modules. The self-check module 319 may automatically try to resolve errors associated with the task output and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of code, code tasks, LLM accuracy, recommendations, or suitable equivalents.

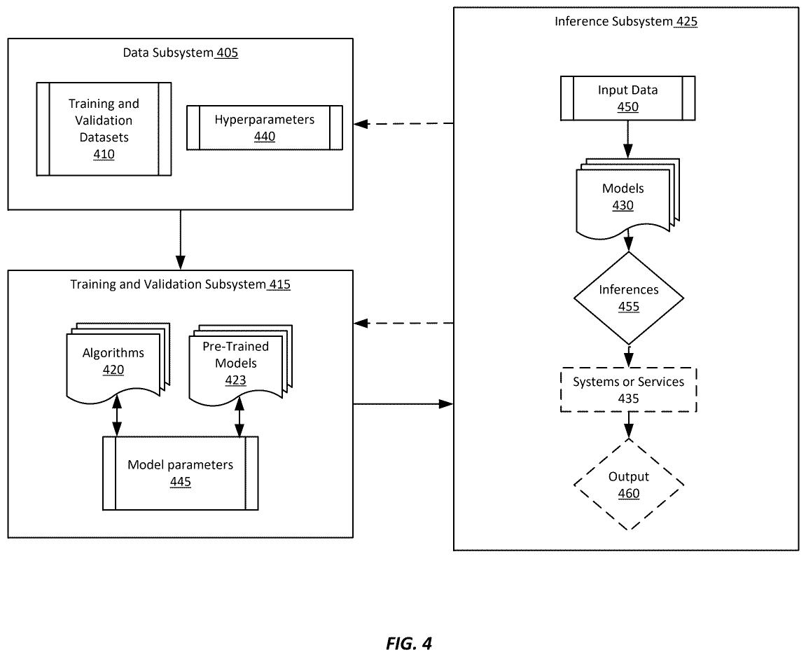

FIG. 4 shows a block diagram of an AI Platform 400 comprising several subsystems that work together to train, validate, and implement one or more machine learning models in accordance with various embodiments. The AI Platform 400 may be executed as part of the code tool, code agent system, and/or AI code agent described in FIGS. 1, 2, and 3 to train or fine-tune one or more machine learning models (e.g., one or more generative models) with training data—and deploy and use said one or more machine learning models as described herein.

The AI Platform 400 comprises a data subsystem 405 for collecting, generating, preprocessing, and labeling of training and validation data sets 410, training and validation subsystem 415 that facilitates the training and validation of one or more machine learning algorithms 420 or one or more pre-trained machine learning models 423, and inference subsystem 425 for deploying and implementing one or more trained machine learning models 430 independently or in combination with one or more other systems or services 435 for downstream processes.

As used herein, machine learning algorithms (also described herein as simply algorithm or algorithms) are procedures that are run on data sets (e.g., training and validation data sets) and perform pattern recognition on data sets, learn from the data sets, and/or are fit on the data sets. Examples of machine learning algorithms include linear and logistic regression, decision trees, artificial neural networks, k-means, transformer architectures with attention mechanisms, and k-nearest neighbor. In contrast, machine learning models (also described herein as simply model or models) are the output of the machine learning algorithms and are comprised of model data and a prediction algorithm. In other words, the machine learning model is the program that is saved after running a machine learning algorithm on training data and represents the rules, numbers, and any other algorithm-specific data structures required to make inferences. For example, a linear regression algorithm may result in a model comprised of a vector of coefficients with specific values, and a transformer architecture with attention mechanisms may result in a LLM that utilizes self-attention mechanisms, allowing the model to weigh the importance of different words in a sentence when making predictions.

In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original data set. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. For example, Large Vision Language Models (VLMs) are advanced AI systems that integrate computer vision and natural language processing (NLP) to process and generate text based on visual inputs like images or videos. These models are multimodal, meaning they can handle both text and visual data simultaneously, enabling tasks such as image captioning, visual question answering (VQA), image generation, and object detection. These models integrate diverse data sets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse data sets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse data sets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

### Data Subsystem

Data subsystem 405 is used to collect, generate, preprocess, and label data to be used to train and validate one or more machine learning algorithms 420 or one or more pre-trained machine learning models 423. The data collection can include exploring various data sources such as public data sets, private data collections, or real-time data streams, depending on a project's needs. In some instances, a data source is a public or online repository of information or examples pertinent to a general or target domain space (e.g., Java codebase or code repository). Many domains have publicly available data sets provided by governments, universities, or organizations. For example, many government and private entities offer data sets on healthcare, environmental data, and more through various portals. For proprietary needs, data might be available through partnerships or purchases from private companies that specialize in data aggregation. In other instances, a data source is a private repository of information or examples pertinent to a general or target domain space (e.g., Java codebase or code repository). For example, a data source can be the storage device that stores code accessed by the code tool, code agent system, and/or AI code agent described in FIGS. 1, 2, and 3. Once a data source is identified, data subsystem 405 can be used to collect data through appropriate methods such as downloading from online repositories, web scraping, using APIs for real-time data, creating data sets through surveys and requests for access, or by running programs or scripts. The acquired raw data may be further preprocessed to generate the training and validation data sets 410.

In some instances, raw data (e.g., text scripts and associated audio) may be generated as opposed to being collected or acquired. Data generating may comprise data synthesis and/or data augmentation. Different data synthesis and/or data augmentation techniques may be implemented by the data subsystem 405 to generate data to be used for the training and validation subsystem 415. Data synthesizing involves creating entirely new data points from scratch. Data synthesis may be used when real data is insufficient, too sensitive to use, or when the cost and logistical barriers to obtaining more real data are too high. The synthesized data should be realistic enough to effectively train a machine learning model, but distinct enough to comply with regulations (e.g., copyright and data privacy), if necessary. Data augmentation, on the other hand, refers to techniques used to artificially expand the size of a data set by creating modified versions of existing data examples. The primary goal of data augmentation is to increase variation in the data in order to make the model more robust to variations it might encounter in the real world, thereby improving its ability to generalize from the training data to unseen data. This is especially common in image and speech recognition tasks but is applicable to other data types as well. For images, data augmentation may include rotations, flipping, scaling, or altering the lighting conditions. For text, data augmentation may include synonyms replacement, back translation, or sentence shuffling. For audio, data augmentation may include changes made to pitch, speed, or background noise.

Preprocessing may be implemented by the data subsystem 405, serving as a bridge between raw data acquisition and effective model training. The primary objective of preprocessing is to transform the raw data into a format that is more suitable and efficient for analysis, ensuring that the data fed into machine learning algorithms or pretrained models is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve.

Other raw data preprocessing techniques that may be utilized include data cleaning, normalization, feature extraction, dimensionality reduction, and the like. Data cleaning may involve removing duplicates, filling in missing values, or filtering out outliers to improve data quality. Normalization involves scaling numeric values to a common scale without distorting differences in the ranges of values, which helps prevent biases in the model due to the inherent scale of features. Feature extraction involves transforming the input data into a set of useable features, possibly reducing the dimensionality of the data in the process. For instance, in audio analysis, feature reduction techniques such as Principal Component Analysis (PCA), Linear Discriminant Analysis (LDA), t-Distributed Stochastic Neighbor Embedding (t-SNE), Non-Negative Matrix Factorization (NMF), and feature selection can be used for simplifying the representation of audio signals while retaining the most relevant information for tasks like classification, recognition, or synthesis. These techniques not only help in reducing the computational load on the model but also in mitigating issues like overfitting by simplifying the data without losing critical information.

In the instance that AI Platform 400 is used for supervised or semi-supervised learning of machine learning models, labeling techniques can be implemented as part of the data collection. The quality and accuracy of data labeling directly influence the model's performance, as labels serve as the definitive guide that the model uses to learn the relationships between the input features and the desired output. Particularly in complex domains such as image analysis, natural language processing, or medical diagnosis, precise and consistent labeling is important because it provides the ground truth or target outcomes against which the model's predictions are compared and adjusted during training. Effective labeling ensures that the model is trained on correct and clear examples, thus enhancing its ability to generalize from the training data to real-world scenarios. In some instances, the annotation labels and ground truth values (labels) are appended or annotated within the raw data. For example, when the raw data includes text scripts, the labels may include one or more spans and corresponding named entities.

Labeling techniques can vary significantly depending on the type of data and the specific requirements of the project. Manual labeling, where human annotators label the data, is one method that can be used. This approach may be useful when a detailed understanding and judgment are required, such as in labeling medical text or categorizing text data where context and subtlety are important. However, manual labeling can be time-consuming and prone to inconsistency, especially with a large number of annotators. To mitigate this, semi-automated labeling tools may be used as part of data subsystem 405 to pre-label data using algorithms, which human annotators may then review and correct as needed. Another approach is active learning, a technique where the model being developed is used to label new data iteratively. The model suggests labels for new data points, and human annotators may review and adjust certain predictions such as the most uncertain predictions. This technique optimizes the labeling effort by focusing human resources on a subset of the data, e.g., the most ambiguous cases, improving efficiency and label quality through continuous refinement.

Once collected, generated, preprocessed, and/or labeled, the data may then be split into the training and validation data sets 410. The training and validation data sets 410 may comprise the raw data and/or the preprocessed data. The training and validation data sets 410 are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen data set for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall data set in each subset. A simple random split (e.g., a 70/20/10%, 80/10/10%, or 60/25/15%) is the most straightforward approach, where examples from the data are randomly assigned to each of the three sets. In some instances, the splitting is performed such that 70% of the training and validation data sets 410 are for training, 10% are for validation, and 20% are for testing. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied data sets.

Data subsystem 405 is also used for collecting, generating, setting, or implementing model hyperparameters 440 for the training and validation subsystem 415. The hyperparameters control the overall behavior of the models. Unlike model parameters 445 that are learned automatically during training, hyperparameters 440 are set before training begins and have a significant impact on the performance of the model. For example, in a neural network such as that of an LLM, hyperparameters include the learning rate, number of layers, number of neurons/nodes per layer, activation functions, convolution kernel width, the number of kernels for a model, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

### Training, Validation, and Testing

The training and validation subsystem 415 is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries are utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models 430 or fine-tuning is subsequent training phases for fine-tuning machine learning models 430 where the model learns to make predictions or decisions based on data training data provided from the training and validation data sets 410. During this phase, the model iteratively adjusts its internal model parameters 445 to achieve a preset optimization condition. In a supervised machine learning training process, the preset optimization condition can be achieved by minimizing the difference between the model output (e.g., predictions, classifications, or decisions) and the ground truth labels in the training data. In some instances, the preset optimization condition can be achieved when the preset fixed number of iterations or epochs (full passes through the training data set) is reached. In some instances, the preset optimization condition is achieved when the performance on the validation data set stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and validation subsystem 415, the training subset of data is input into the machine learning algorithms 420 or pre-trained models 423 to find a set of model parameters 445 (e.g., weights, coefficients, trees, feature importance, and/or biases) that minimizes or maximizes an objective function (e.g., a loss function, a cost function, a contrastive loss function, a cross-entropy loss function, an Out-of-Bag (OOB) score, etc.). To train the machine learning algorithms 420 or pre-trained models 423 to achieve accurate predictions, “errors” (e.g., a difference between a predicted label and the ground truth label) need to be minimized. In order to minimize the errors, the model parameters can be configured to be incrementally updated by minimizing the objective function over the training phase (“optimization”). Various different techniques may be used to perform the optimization. For example, to train machine learning algorithms or pre-trained models such as a neural network, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters 445 in a manner as to minimize or maximize an objective function. This cycle is repeated until a desired state (e.g., a predetermined minimum value of the objective function) is reached.

The training phase is driven by three primary components: the model architecture (which defines the structure of the algorithm(s) 420 or pretrained model(s) 423), the training data (which provides the examples from which to learn), and the learning algorithm (which dictates how the model adjusts its model parameters). The goal is for the model to capture the underlying patterns of the data without memorizing specific examples, thus enabling it to perform well on new, unseen data.

The model architecture is the specific arrangement and structure of the various components and/or layers that make up a model. In the context of a neural network, the model architecture may include the configuration of layers in the neural network, such as the number of layers, the type of layers (e.g., convolutional, recurrent, fully connected), the number of neurons in each layer, and the connections between these layers. In the context of a LLM comprised of a transformer architecture, which utilizes self-attention mechanisms to process and generate human-like text. The transformer model comprises an encoder-decoder structure, where the encoder processes the input text, and the decoder generates the output. The self-attention mechanism allows the model to weigh the importance of different words in a sentence, capturing long-range dependencies and contextual relationships. This architecture enables the model to handle large-scale data and understand complex language patterns. During training, the optimization algorithm such as Adam is used to minimize the loss function through backpropagation, and regularization techniques like dropout are employed to prevent overfitting, resulting in a robust and efficient language model capable of performing various natural language processing tasks such as predicting the ADR relations.

The model architecture also encompasses the choice and arrangement of features and algorithms used in various models, such as neural networks and transformers. The architecture determines how input data is processed and transformed through various computational steps to produce the output. The model architecture directly influences the model's ability to learn from the data effectively and efficiently, and it impacts how well the model performs tasks such as classification, regression, or prediction, adapting to the specific complexities and nuances of the data it is designed to handle.

The learning algorithm is the overall method or procedure used to adjust the model parameters 445 to fit the data. It dictates how the model learns from the data provided during training. This includes the steps or rules that the algorithm follows to process input data and make adjustments to the model's internal parameters (e.g., weights in neural networks) based on the output of the objective function. Examples of learning algorithms include gradient descent, backpropagation for neural networks, and splitting criteria in decision trees.

Various techniques may be employed by training and validation subsystem 415 to train machine learning models 430 using the learning algorithm, depending on the type of model and the specific task. For supervised learning models, where the training data includes both inputs and expected outputs (e.g., ground truth labels), gradient descent is a possible method. This technique iteratively adjusts the model parameters 445 to minimize or maximize an objective function (e.g., a loss function, a cost function, a contrastive loss function, etc.). The objective function is a method to measure how well the model's predictions match the actual labels or outcomes in the training data. It quantifies the error between predicted values and true values and presents this error as a single real number. The goal of training is to minimize this error, indicating that the model's predictions are, on average, close to the true data. Common examples of loss functions include mean squared error for regression tasks and cross-entropy loss for classification tasks.

The adjustment of the model parameters 445 is performed by the optimization function or algorithm, which refers to the specific method used to minimize (or maximize) the objective function. The optimization function is the engine behind the learning algorithm, guiding how the model parameters 445 are adjusted during training. It determines the strategy to use when searching for the best weights that minimize (or maximize) the objective function. Gradient descent is a primary example of an optimization algorithm, including its variants like stochastic gradient descent (SGD), mini-batch gradient descent, and advanced versions like Adam or RMSprop, which provide different ways to adjust learning rates or take advantage of the momentum of changes. For example, in training a neural network, backpropagation may be used with gradient descent to update the weights of the network based on the error rate obtained in the previous epoch (cycle through the full training data set). Another technique in supervised learning is the use of decision trees, where a tree-like model of decisions is built by splitting the training data set into subsets based on an attribute value test. This process is repeated on each derived subset in a recursive manner called recursive partitioning.

In unsupervised learning, where training data does not include labels, different techniques are used. Clustering is one method where data is grouped into clusters that maximize the similarities of data within the same cluster and maximize the differences with data in other clusters. The K-Means algorithm, for example, assigns each data point to the nearest cluster by minimizing the sum of distances between data points and their respective cluster centroids. Another technique, Principal Component Analysis (PCA), involves reducing the dimensionality of data by transforming it into a new set of variables, the principal components, which are uncorrelated and ordered so that the first few retain most of the variation present in all of the original variables. These techniques help uncover hidden structures or patterns in the data, which can be essential for feature reduction, anomaly detection, or preparing data for further supervised learning tasks.

Validating is another phase of developing machine learning models 430 where the model is checked for deficiencies in performance and the hyperparameters 440 are optimized based on validation data provided from the training and validation data sets 410. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

An exemplary validation process includes iterative operations of inputting the validation subset of data into the trained algorithm(s) using a validation technique such as K-Fold Cross-Validation, Leave-one-out Cross-Validation, Leave-one-group-out Cross-Validation, Nested Cross-Validation, or the like, to fine-tune the hyperparameters and ultimately find the optimal set of hyperparameters. In some instances, a 5-fold cross-validation technique may be used to avoid overfitting the trained algorithm and/or to limit the number of selected features per split to the square-root of the total number of input features. In some instances, training data set is split into 5 equal-size cohorts (or about equal-size), and every four of the cohorts are used to train an algorithm to generate five models (e.g, cohorts #1, 2, 3, and 4 are used to train and generate model 1, cohorts #1, 2, 3, and 5 are used to train and generate model 2, cohorts #1, 2, 4, and 5 are used to train and generate model 3, cohorts #1, 3, 4, and 5 are used to train and generate model 4, and cohorts #2, 3, 4 and 5 are used to train and generate model 5). Each model is evaluated (or validated) using the unused cohort in the training (e.g., for model 5, cohort #1 is used for validation). The overall performance of the training can be evaluated by an average performance of the five models. K-fold cross-validation provides a more robust estimate of a model's performance compared to a single training/validation split because it utilizes the entire data set for both training and evaluation and reduces the variance in the performance estimate.

Once a machine learning model has been trained and validated, it undergoes a final evaluation using test data provided from the training and validation data sets 410, which is a separate subset of the data that has not been used during the training or validation phases. This step is crucial as it provides an unbiased assessment of the model's performance in simulating real-world operation. The test data set serves as new, unseen data for the model, mimicking how the model would perform when deployed in actual use. During testing, the model's predictions are compared against the true values in the test data set using various performance metrics such as accuracy, precision, recall, and mean squared error, depending on the nature of the problem (classification or regression). This process helps to verify the generalizability of the model-its ability to perform well across different data samples and environments-highlighting potential issues like overfitting or underfitting and ensuring that the model is robust and reliable for practical applications. The machine learning models 430 are fully validated and tested once the output predictions have been deemed acceptable by user defined acceptance parameters. Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

### Inference Phase for Machine Learning Models

The inference subsystem 425 is comprised of various components for deploying the machine learning models 430 in a production environment (e.g., use as cloud service as described with respect to FIGS. 7-11). Deploying the machine learning models 430 includes moving the models from a development environment (e.g., the training and validation subsystem 415, where it has been trained, validated, and tested), into a production environment where it can make inferences on real-world data (e.g., input data 450). This step typically starts with the model being saved after training, including its parameters and configuration such as final architecture and hyperparameters. It is then converted, if necessary, into a format that is suitable for deployment, depending on the deployment environment. For instance, a model trained in a scientific computing environment such as Python might be converted into a Java-friendly format for integration into a larger enterprise application.

Deployment can be conducted on various platforms, including on-premises servers or cloud environments like Oracle's Cloud Infrastructure (OCI), as described in greater detail with respect to FIGS. 7-11. In some instances, a portion of or the code tool, code agent system, and/or AI code agent described in FIGS. 1, 2, and 3 can be bundled into an application using a software framework such as Gradio or LangChain, which is executable on one or more of the various platforms. A Gradio application is an open-source Python package that allows a user to quickly build a demo or web application for their machine learning model, API, or any arbitrary Python function (e.g., a could service application). LangChain provides utilities for integrating generative models into applications. The application can be built to enable users to play around with the training data generator in a playground mode, as well as generate training data set in bulk, train models using the training data set, and use the models in a production environment.

Once deployed, the model is ready to receive input data 450 and return outputs (e.g., inferences 455). In some instances, the model resides as a component of a larger system or service (e.g., including additional downstream applications 435). In some instances, the models 430 and/or the inferences 455 can be used by the downstream applications 435 to provide further information. For example, the inferences 455 can be used for converting text to audio, detecting audio, converting audio to text, executing code, and the like. The downstream applications can be configured to generate an output 460. In some instances, the output 460 comprises a report including inferences 455 and information generated by the downstream applications 435.

To manage and maintain its performance, a deployed model may be continuously monitored to ensure it performs as expected over time. This involves tracking the model's prediction accuracy, response times, and other operational metrics. Additionally, the model may require retraining or updates based on new data or changing conditions in the environment it is applied in. This can be useful because machine learning models can drift over time due to changes in the underlying data they are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Knowledge Augmentation

As discussed herein, foundational generative models are rapidly improving. However, enhancing these models, especially strong code models, is a highly challenging task. Even with advanced code models, as demonstrated in the Alpha Program (using Phind-CodeLlama-34B-V2), many issues arise in real-world scenarios when developers rely on responses from code models. More specifically, conventional code models have been trained on vast amounts of web-scale data, giving them a solid foundation in general coding knowledge. However, they still face challenges when it comes to specific code tasks or skills for low-resource programming languages. Studies conducted with internal developers revealed that even a powerful code model like Llama 3.1 struggled with certain low-resource programming language coding skills or tasks such as code generation, completion, explanation, documentation or unit test generation. A major challenge in deploying generative models as code models for low-resource programming languages is their lack of knowledge. As discussed above in the context of API methods, the two primary issues observed are API hallucination, where the model generates non-existent API methods, and API inaccuracy, where the model produces incorrect syntax for existing methods. These errors are particularly common for low-frequency APIs due to the scarcity of publicly available code examples, leading to insufficient training data and suboptimal model performance.

More specifically, in the deployment of generative models such as LLMs for SuiteScript code generation, frequent API hallucinations, where the model generates non-existent methods, as well as incorrect API usage, where it produces invalid syntax for existing functions, were observed. Fine-tuning on code samples failed to resolve these errors. Analysis revealed that while the models often recognize valid API functions, they sometimes substitute them with fabricated ones. For instance, in the below example it is shown, both the base LLM and its fine-tuned variant incorrectly used .getCurrentLineValue( ) and .setCurrentLineText( ) instead of the correct .getCurrentSublistValue( ) and .setCurrentSublistValue( ).

The following example demonstrates a SuiteScript code generation task used to evaluate both the base LLM and a variant LLM fine-tuned with code examples. The prompt given to both models was:

“You are highly skilled in SuiteScript coding, with a strong ability to solve problems, self-check for issues, and consistently generate accurate, high-quality code.
Provide a correct, complete, and standalone solution to the following SuiteScript problem. Use SuiteScript 2.x API.
Write a client script function to perform custom validation when deleting a line in the ‘partners’ sublist. The function retrieves the currentRecord object and the sublist name from the context parameter. If the sublist name is ‘partners’ and the value of the ‘partner’ field in the current line is ‘55’, the function sets the value of the ‘memo’ field to ‘Removing partner sublist’.”
Variant LLM Fine-Tuned with Code Examples Output:
Here's a complete and standalone SuiteScript 2.x client script that performs the required validation:

```
‘javascript
/
*@NApiVersion 2.x
*@NScriptType ClientScript
*/
define([′N/record′], function(record) {
  function validateLine(context) {
    var currentRecord = context.currentRecord;
    var sublistName = context.sublistId;
    if (sublistName === ′partners′) {
      var partnerValue = currentRecord.getCurrentLineValue({
        sublistId: ′partners′, fieldId: ′partner′
      });
      if (partnerValue === ′55′) {
        currentRecord.setCurrentLineText({
          sublistId: ′partners′, fieldId: ′memo′, text: ′Removing partner sublist′
        });
      }
    }
  }
  return { validateDelete: validateLine, validateInsert: validateLine,
validateFieldChanged: validateLine };});‘This script defines a validateLine function that
checks whether the sublist being deleted is the ″partners″ sublist and whether the ″partner″ field
in the current line is ′55′. If both conditions are met, it sets the value of the ″memo″ field to
′Removing partner sublist′.
The ‘validateLine‘ function is then assigned to three events (‘validateDelete‘, ‘validateInsert‘,
‘validateField‘) in the returned object. This ensures that the validation logic runs whenever a line
is deleted, inserted, or edited in any sublist.
Note that this script uses the ‘getCurrentLineValue‘ method to get the value of the ″partner″ field
in the current line and the ‘setCurrentLineText‘ method to set the value of the ″memo″ field.
These methods are part of the ‘currentRecord‘ obiect provided by the ‘context‘ parameter.
```

Base Model Output—The base model was given the same SuiteScript problem and produced a similar output, using the methods getCurrentLineValue( ) and setCurrentLineText( ).

```
‘javascript
/
*@NApiVersion 2.x
*@NScriptType ClientScript
*/
define([′N/record′], function (record) {
function validateLine(context) {
  var currentRecord = context.currentRecord;
  var sublistName = context.sublistId;
  if (sublistName === ′partners′) {
    var partnerValue = currentRecord.getCurrentLineValue({
      sublistId: ′partners′, fieldId: ′partner′
    });
    if (partnerValue === ′55′) {
      currentRecord.setCurrentLineText({
        sublistId: ′partners′, fieldId: ′memo′, text: ′Removing partner sublist′
      });
    }
  }
}return { validateDelete: validateLine, validateInsert: validateLine, validateFieldChanged:
validateLine};});‘This script defines a validateLine function that checks whether the sublist
being deleted is the ″partners″ sublist and whether the ″partner″ field has a value of ′55′. If both
conditions are met, it sets the ″memo″ field to ′Removing partner sublist′. The validateLine
function is then assigned to three different events (validateDelete, validateInsert,
validateFieldChanged) to ensure that the validation occurs whenever a line is deleted or
modified.Note that this script uses the N/record module to interact with the NetSuite record,
which provides methods like getCurrentLineValue( ) and setCurrentLineText( ). These methods
allow you to access and modify fields on the current line of the sublist.
```

Additional Code Generation Task with API Reference Instruction—For further evaluation, the models were prompted to generate an API reference before code generation using the following prompt:

“You are highly skilled in SuiteScript coding, with a strong ability to solve problems, self-check
for issues, and consistently generate accurate, high-quality code.
Provide a correct, complete, and standalone solution to the following SuiteScript problem. Use
SuiteScript 2.x API. Before generating the code, generate API reference. Write a client script
function to perform custom validation when deleting a line in the ‘partners' sublist. The function
retrieves the currentRecord object and the sublist name from the context parameter. If the sublist
name is ‘partners' and the value of the ‘partner’ field in the current line is ‘55’, the function sets
the value of the ‘memo’ field to ‘Removing partner sublist’.”

Variant LLM Fine-Tuned with Code Examples Output:

```
API Reference
- currentRecord (Object): Represents the current record being processed.
  + getSublist( ) (Function): Returns the specified sublist object.
  + getCurrentLineItemValue( ) (Function): Returns the value of the specified field on the
current line item.
  + setCurrentLineItemValue( ) (Function): Sets the value of the specified field on the current
line item.
- context (Object): Provides information about the current execution context.
  + sublistId (Property): The ID of the sublist that triggered the script.SuiteScript 2.x Code
‘javascript
/
*@NApiVersion 2.x
*@NScriptType ClientScript
*/
define([′N/record′], function(record) {
  function validateDeleteLine (scriptContext) {
    var currentRecord = scriptContext.currentRecord;
    var sublistName = scriptContext.sublistId;
    if (sublistName === ′partners′) {
      var partnerFieldValue = currentRecord.getCurrentLineItemValue({
        sublistId: sublistName, fieldId: ′partner′
      });
      if (partnerFieldValue === ′55′) {
        currentRecord.setCurrentLineItemValue({
          sublistId: sublistName, fieldId: ′memo′, value: ′Removing partner sublist′
}); } } }});
‘‘‘
This script defines a client script function called ‘validateDeleteLine‘, which checks if the sublist
being deleted is the ″partners″ sublist and if the value of the ″partner″ field on the current line is
′55′. If both conditions are true, it sets the value of the ″memo″ field on the current line to
′Removing partner sublist′.
To use this script, create a new client script in NetSuite, paste the above code into the script file,
and then deploy the script to your desired record type. Make sure to set the script's trigger to
″Validate Delete Line″ and select the ″partners″ sublist as the trigger sublist.
```

### Base Model Output:

```
API Reference
- currentRecord (Object): Represents the current record being processed.
  + getSublist( ) (Function): Returns the specified sublist object.
  + getCurrentLineItemValue( ) (Function): Returns the value of the specified field on the
current line item.
  + setCurrentLineItemValue( ) (Function): Sets the value of the specified field on the current
line item.
- context (Object): Provides information about the current execution context.
  + sublistId (Property): The ID of the sublist that triggered the script.
Client Script Code
‘javascript/*@NApiVersion 2.x*@NScriptType ClientScript*/define([′N/currentRecord′],
function(currentRecord) {
      /**
      *Function to be executed when a line is deleted in the partners sublist.
      *
      *@param {Object} context - The execution context.
    */
    function validateDeletePartner (context) {
    // Get the current record object
    var rec = currentRecord. get( );
  // Check if the sublist name is ″partners″
    if (context.sublistId === ′partners′) {
  // Get the value of the ″partner″ field in the current line
      var partnerValue = rec. getCurrentLineItemValue({
        sublistId: ′partners′, fieldId: ′partner′
      });
      // Check if the partner value is ′55′
      if (partnerValue === ′55′) {
        // Set the value of the ″memo″ field to ′Removing partner sublist′
        rec. setCurrentLineItemValue({
          sublistId: ′partners′, fieldId: ′memo′, value: ′Removing
  partner sublist′
        });
      }
  }
});‘
This script defines a client-side function ‘validateDeletePartner‘ that checks if the sublist name is
″partners″ and if the value of the ″partner″ field in the current line is ′55′. If both conditions are
met, it sets the value of the ″memo″ field to ′Removing partner sublist′.
To use this script, you would need to create a new client script in NetSuite, paste this code into it,
and then deploy it to your account. You can then add a trigger to call this script whenever a line
is deleted in the ″partners″ sublist.
```

However, both models continued to produce incorrect API references, reinforcing hallucinated functions. It was hypothesized that training solely on code samples is insufficient to address the API hallucination.

To address these challenges and others, the framework and techniques described herein implement a new training schema that integrates explicit API knowledge into a generative model through:
1. API Reference Question-Answer Pairs-structured Q&A data explicitly reinforcing API functionalities.
2. API Descriptions in Code-augment each code sample in training data with API description to provide contextual understanding of API usage.

By incorporating explicit API knowledge, this approach enhances the model's accuracy in API recognition and reduces hallucination. Experimentation results show that generative models trained using this new training schema have improved code generation performance for low-resource programming languages such as SuiteScript. It should be understood, however, that the framework and techniques described herein can be extended to general use cases to include any other languages with source knowledge such as developer guides and tutorials or style guides and linter configurations to teaching a model the context, best practices, problem-solving patterns, syntactical rules, and/or formal definitions of a programming language and address hallucination and accuracy challenges beyond those originating specifically from a deficiency in API knowledge.

### Knowledge Augmentation Framework

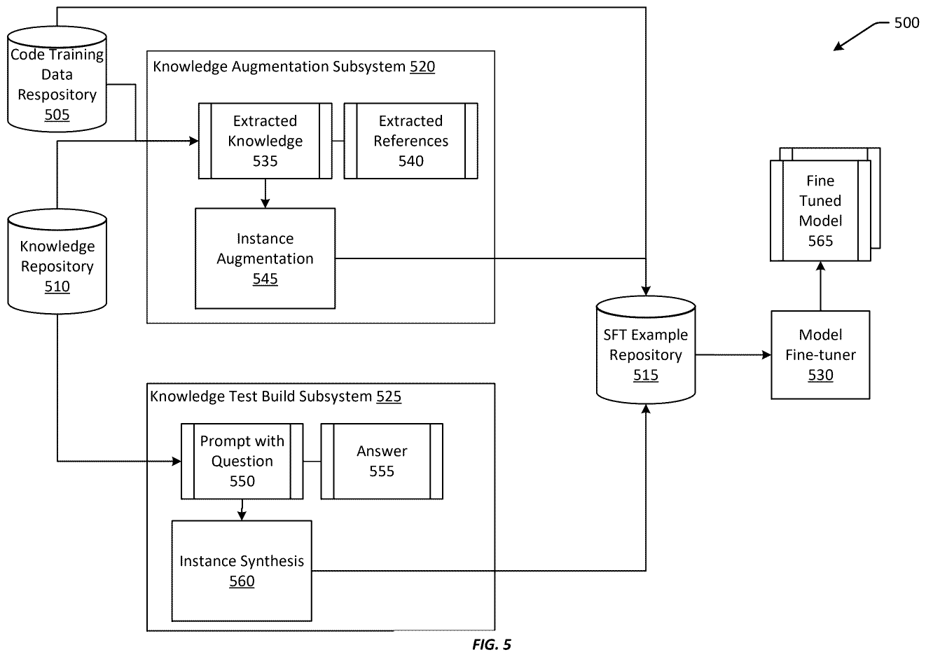

FIG. 5 is a simplified block diagram illustrating aspects of the knowledge augmentation framework 500 configured to inject external knowledge (e.g., API knowledge) into a training data set comprised of training examples by creating augmented training examples based at least in part on adding an instruction to generate a description of the relevant API method in the prompt of the training example, and adding the relevant API method and the corresponding role description for a code sample to the corresponding gold label solution. The knowledge augmentation framework 500 can be implemented using software only, hardware only, firmware only, or any combination of hardware, software, and/or firmware. The augmented training data set generated by the knowledge augmentation framework 500 can be used to fine-tune a code model (e.g., SFT) included as part of a code agent system or code tool (e.g., code tool 104 from FIG. 1, code model 222 from FIG. 2).

As depicted in FIG. 5, the knowledge augmentation framework 500 comprises subsystems, repositories, and models including but not limited to code training data repositories 505, knowledge repositories 510, SFT example repositories 515, knowledge augmentation subsystem 520, knowledge test build subsystem 525, and model fine-tuner 530. Each subsystem can be understood to include an execution of one or more processes and/or programs implemented with software, hardware, and/or firmware within a system (e.g., as described with respect to FIGS. 7-11). Moreover, it should be understood that the one or more processes and/or programs can be executed as part of an iterative process that ultimately generates a set of training examples. Iteration or an iterative process being the process of repeating a set of instructions or steps multiple times or cycles. For example, a set of instructions or steps may be executed for generating one or more augmented training examples and repeatedly executing the set of instructions or steps multiple times or over multiple cycles results in the generation of multiple augmented training examples (typically different augmented training examples), i.e., the set of augmented training examples. Each cycle of the set of instructions or steps may be executed serially, or multiple cycles of the set of instructions or steps may be executed in parallel.

In some implementations, users such as software developers can keep and manage their source code and related files in one or more code repositories. The one or more code repositories serve as a centralized platform for version control, collaboration, and code management, allowing multiple users to contribute to a project simultaneously while tracking changes, managing revisions, and resolving conflicts. The vast amount of code data can be utilized as bootstrapping to guide generators towards producing code task or skill examples that are relevant to user use cases for fine-tuning an existing or pre-trained generative model with user-specific code knowledge. As discussed in detail herein, the one or more code repositories can be identified from internal sources or within one or more systems associated with a given enterprise (i.e., owned, operated, and/or used by a given enterprise). Code files are extracted from the code repositories. In some instances, the code files are extracted from the code repositories based on a minimum successful build count (e.g., mbc>=x where x is a number in a range of [1,5]). Table 2 below provides a summary of exemplary data that can be extracted from Java code repositories:

TABLE 2

| | | Unfiltered | Count w/ | Count w/ | Count w/ | Count w/ |
|---|---|---|---|---|---|---|
| | Data Source | Count | mbc >=1 | mbc >=2 | mbc >=3 | mbc >=5 |
| 1 | Java source codes | 1301280 | 734503 | 232808 | 150406 | 86179 |
| 2 | Java unit test | 336620 | 190674 | 35384 | 11330 | 3486 |
| | source codes | | | | | |
| 3 | README.md files | 79274 | 43491 | 10025 | 3619 | 1166 |
| 4 | Other MD files | 160999 | 74727 | 33032 | 27423 | 463 |
| 5 | Java unit test | 571339 | 166080 | 32374 | 9868 | 2832 |
| | pairs | | | | | |
| 6 | Java | 518802 | 279713 | 135429 | 115951 | 77024 |
| | documentation | | | | | |
| | pairs | | | | | |
| 7 | Python source | 387383 | 189182 | 22550 | 3698 | 1270 |
| | codes | | | | | |

In some instances, the unit test pair code files are extracted by matching pattern, for example, of X.java with XTest.java, within the same code repository. This can help improve unit test generation capability of existing generative models. In some instances, code documentation pair files are extracted if more than 50% of the properties/attributes of the code, for example, classes/methods for Java code, are documented. A rule-based regex matching may be applied to estimate the documented properties/attributes (e.g., classes/methods). The code files for undocumented source code may then be acquired by removing all docs such as Javadocs from the documented version. In some instances, README files may be removed from the code files or ignored since they contain random notes which may not be useful for model training. As a result, the following data sources or code files can be extracted from the code repositories, leveraged and selected for use in the knowledge augmentation framework 500 and processes: (i) source codes with raw code files (e.g., raw Java code files), (ii) unit test sources codes (e.g., Java unit test source codes) with, (iii) other types of related source codes (e.g., Python). Once the code files are extracted, they may be used to generate training data (e.g., examples stored in the code training data repositories 505) for fine-tuning one or more pre-trained generative models on one or more code skills or tasks including those shown in Table 3.

TABLE 3

| | Java Code task | Description |
|---|---|---|
| 1 | Unit Test | Input: existing functions from a given code snippet |
| | Generation | Output: unit test code |
| 2 | Code | Input: code snippet lacking documentation, such as Javadocs |
| | Documentation | Output: code with documentation added |
| 3 | Code Explanation | Input: provided code snippet |
| | | Output: detailed explanation of the code in natural language |
| 4 | Code Review | Input: existing code snippet, with or without a diff (possibly |
| | | from a PR request) |
| | | Output: code review that includes: |
| | | Identifying incorrect or inefficient code lines |
| | | Highlighting missing libraries |
| | | Detecting potential bugs in the code where applicable |
| 5 | Code Completion | Input: incomplete code with general or inline instructions |
| | | Output: completed code along with an explanation |

The code training data repositories 505 are a storage location where one or more data sets comprising code training data examples are stored. Each data set of the one or more datasets comprises training examples for a given code task, e.g., code generation, code review, unit test code generation, code explanation, etc. Each example may be generated using the extracted code files and is comprised of a prompt that requests a generative model such as a LLM to perform a given code task, along with the corresponding gold label solution (ground truth). More specifically, the code training examples are constructed as duplets in the form of <x_prompt, y_c>:
x_prompt: The prompt for performing the given code task.
y_c: The completion from performing the given code task.

In some implementations, the training examples may be generated by associating the prompt including instruction for the given code task with the completion (e.g., code snippet extracted from the code files) and storing the duplets and association in a data store, table and/or matrix (e.g., the one or more code training data repositories 505) as a data set. In some implementations, the training examples may be generated by labelling a prompt including instruction for the given code task as an input and labelling a corresponding completion as an output to create an input-output pair. Consequently, each example contains a prompt including instruction for the given code task and a corresponding completion.

As described above, the challenges of fine-tuning models using only the data sets in the one or more code training data repositories 505 is the use of incorrect information such as API references and functions that do not follow a low-resource programming language such as SuiteScript 2.x. This is due to the source models not having knowledge of the low-resource programming language and the models fill the gaps with other versions of the low-resource programming language such as SuiteScript 1.0 API reference or hallucinate in the generation of the completion (e.g., generates non-existent API methods or produce incorrect syntax for existing methods). The knowledge augmentation subsystem 520 and knowledge test build subsystem 525 are implemented to address these challenges by improving model accuracy in generating target programming language code by reducing hallucinations and ensuring API correctness. More specifically, the data sets in the one or more code training data repositories 505 are augmented, using knowledge augmentation subsystem 520, to add an instruction to generate a description of the relevant API method in the prompt of the training example and add the relevant API method and the corresponding role description for the code sample to the corresponding gold label solution or completion. The knowledge test build subsystem 525 may additionally or alternatively be implemented to generate synthetic training examples comprising reference Question-Answer Pairs that explicitly reinforce API functionalities.

The knowledge augmentation subsystem 520 utilizes knowledge or information within documents stored in knowledge repositories 510 to generate, using one or more generative models, references for components (e.g., API references) of code examples (also referred to herein as snippets or samples) in a target programming language. The knowledge repositories 510 are a storage location where a curated corpus of documentation (e.g., API documentation) is stored. The corpus of documentation serves as the authoritative knowledge base for augmenting training data (e.g., data (e.g., examples stored in the code training data repositories 505) during fine-tuning. This curated corpus is systematically assembled to include comprehensive, accurate, and up-to-date information about the programming interfaces relevant to the target programming language such as SuiteScript 2.x but is readily extensible to any other low-resource programming language or software framework.

In various embodiments, the curated corpus of documentation comprises several distinct categories of information. First, it may include module references, which document the available modules or libraries within the language ecosystem (for example, N/record, N/search, N/runtime in SuiteScript). For each module, the documentation specifies the module's purpose, supported script types, and any dependencies or usage constraints. Second, the corpus may include method definitions for each module, detailing the available functions or procedures, their method signatures, return types, and governance rules (such as execution limits or permissions). Third, the corpus records parameter specifications may be included for each method, enumerating required and optional parameters, their data types, allowable values, and semantic descriptions. Fourth, script type documentation may be included, providing descriptions of different script types (such as ClientScript, Suitelet, BundleInstallationScript), their roles, execution contexts, entry points, and lifecycle events. Fifth, the corpus may include usage examples and best practices, either extracted from official documentation or synthesized from community sources, to illustrate correct and idiomatic use of APIs. Finally, versioning information and deprecation notices may be tracked to ensure only supported and recommended APIs are presented to the model.

The process of assembling the curated corpus of documentation may begin with automated crawling of official documentation sources, such as the NetSuite SuiteScript API reference website, using web scraping tools or custom scripts that traverse documentation hierarchies, extract structured content, and store it in a searchable database. The extraction pipeline parses HTML, Markdown, or PDF documents, isolates module and method tables, and maps descriptions, parameter lists, and example code blocks into normalized records. In addition to public documentation, the corpus may be augmented with internal or proprietary documentation where available, such as developer wikis, API specification files (OpenAPI/Swagger), or source code annotated with docstrings and comments. Where official documentation is sparse or incomplete, the corpus may be supplemented with community-validated resources, such as technical blog posts, Q&A forum answers (for example, Stack Overflow), or curated code repositories, provided these sources are verified for accuracy and relevance.

To ensure the corpus remains authoritative and current, periodic synchronization with upstream documentation sources may be performed, and updates may be tracked using version control or database change logs. Quality assurance processes, such as manual review or automated schema validation, may be employed to detect and resolve inconsistencies, redundancies, or outdated entries. The curated corpus is then indexed to support fast (e.g., low latency) retrieval by script type, module name, method signature, or keyword, facilitating its integration into downstream component extraction, API reference filtering, and instance augmentation steps.

In alternative embodiments, the corpus may be structured as a knowledge graph or relational database, enabling complex queries and inferencing about API relationships, usage patterns, and compatibility constraints. For extensibility, the schema of the corpus can be adapted to accommodate information such as APIs from other programming languages, frameworks, or domains, including RESTful web services, database drivers, or enterprise software SDKs.

Through these techniques, the knowledge augmentation subsystem 520 ensures that the curated corpus of API documentation provides a robust, reliable foundation for augmenting training data with explicit knowledge (e.g., API knowledge). This, in turn, enables a fine-tuned model to perform code tasks that are both syntactically correct and semantically aligned with the most current and authoritative usage conventions (e.g., API conventions), thereby mitigating the risks of hallucination, inaccuracy, and obsolescence in automated code generation tasks.

For each code example, the knowledge augmentation subsystem 520 executes a component extraction process to obtain extracted knowledge 535. The objective of this process is to precisely determine the components including script type, module imports, entry points, and method calls present in the code, thereby enabling accurate linkage between practical code and the curated corpus of API documentation. This may be implemented as a rule-based parser such as a Python script that leverages the syntactic regularity of SuiteScript code to systematically identify and extract the script type, module imports, entry points, and method calls present in each sample. This extraction contextualizes each code instance and enables mapping between code elements and their corresponding API documentation. While rule-based parsing is preferred for its transparency and reproducibility, alternative embodiments may utilize machine learning-based code parsers, regular expression engines, or other techniques appropriate for the syntax of the target programming language. The parser can be adapted for additional low-resource languages by adjusting its rules to accommodate different formatting conventions.

To illustrate the component extraction process, consider the following example involving SuiteScript 2.x, used in NetSuite:

```
‘javascript
/
* @NApiVersion 2.x
* @NScriptType ClientScript
*/
define([′N/record′, ′N/search′], function(record, search) {
  function validateLine(context) {
    var currentRecord = context.currentRecord;
    var sublistName = context.sublistId;
    if (sublistName === ′partners′) {
      var partnerValue = currentRecord.getCurrentLineValue({
        sublistId: ′partners′, fieldId: ′partner′
      });
      if (partnerValue === ′55′) {
        currentRecord.setCurrentLineText({
          sublistId: ′partners′, fieldId: ′memo′, text: ′Removing partner sublist′
        });
      }
    }
  } return { validateDelete: validateLine, validateInsert: validateLine,
validateFieldChanged: validateLine };});‘
```

In this example, the component extraction process operates as follows:

First, the parser examines the code for metadata annotations and special comments. It identifies the script type by parsing the @NScriptType ClientScript annotation, recognizing that the code is intended to function as a client script within the SuiteScript framework. This information is important for understanding the execution context, lifecycle events, and applicable APIs.

Next, the parser scans the define statement to enumerate the module imports. Here, it detects that the code imports the N/record and N/search modules, which respectively provide APIs for interacting with NetSuite records and for performing searches against NetSuite data. The parser records these module names and associates them with their documented interfaces in the curated corpus.

The parser then traverses the body of the script to extract method calls. For instance, it identifies calls to currentRecord.getCurrentLineValue( ) and currentRecord.setCurrentLineText( ), noting the method names, invocation context (object or module), and parameter objects. It further records the use of parameters such as sublistId, fieldId, and text, capturing the structure and semantics of each call. By mapping these method calls to the corresponding entries in the API documentation, the process ensures that subsequent augmentation steps will reference the correct and authoritative usage patterns.

In alternative embodiments, component extraction may be performed using static analysis techniques that parse abstract syntax trees (ASTs) or leverage language server protocols (LSPs) to resolve symbol references and method overloads. For languages with less regular syntax or dynamic code loading, machine learning models trained on annotated code corpora may be employed to predict script types, extract modules, and classify method calls with high accuracy. Additionally, the extraction logic may be extended to capture additional metadata, such as event handlers, callback functions, or user-defined types, further enriching the context available for augmentation.

The extracted knowledge 535 (e.g., script type, module imports, entry points, and method calls) are then packaged into structured records, which form the basis for downstream API reference retrieval and filtering. This enables the knowledge augmentation subsystem 520 to ground each code example in its correct API context, facilitating the code tasks such as the generation of code that is both syntactically and semantically aligned with best practices and documentation standards. Through this approach, the component extraction process ensures that the fine-tuning pipeline is robust, extensible, and capable of adapting to new languages, frameworks, or evolving API conventions. By providing a transparent and reproducible method for linking practical code to authoritative API knowledge, this process facilitates the overall efficacy of the API knowledge augmentation process.

Following component extraction, the knowledge augmentation subsystem 520 executes an API reference extraction process. The objective of this process is to retrieve, from the curated corpus of API documentation stored in knowledge repositories 510, the exact references 540 that elucidate the semantics, usage patterns, and parameter requirements of each code component identified during component extraction. This ensures that subsequent augmentation steps are grounded in the most current and accurate API knowledge available for the target programming language.

To illustrate the API reference extraction process, consider the previously described SuiteScript 2.x client script example, which utilizes the ClientScript script type and imports the N/record module. The code invokes two primary methods: getCurrentLine Value and setCurrentLineText on the currentRecord object. Upon extracting these components, the API reference extraction process proceeds as follows:

First, the process queries the curated corpus for documentation specific to the script type, in this case, ClientScript. The documentation entry for ClientScript describes its role (executing on the client side of the NetSuite platform), its lifecycle events (such as validateDelete, validateInsert, and validateFieldChanged), and any constraints or supported modules. This information establishes the boundaries within which the script operates and informs which API methods are permissible.

Next, the process targets the imported modules, here N/record. The API documentation for N/record is retrieved, detailing its purpose (providing interfaces for manipulating NetSuite records), its supported methods, and the applicable script types. The documentation specifies the methods available within N/record, their signatures, parameter lists, return types, and governance rules, such as execution quotas and permissions.

Finally, the process focuses on the method calls within the code example. For each method such as getCurrentLine Value and setCurrentLineText the extraction logic retrieves the full documentation entries, including method definitions, parameter specifications, example usage, and any applicable notes or caveats. For instance, the documentation for getCurrentLine Value would indicate that this method retrieves the value of a specified field from the current line in a sublist, requiring parameters such as sublistId and fieldId. Similarly, the documentation for setCurrentLineText would clarify its function in setting text values for fields on the current line, enumerating required parameters and permissible value types.

In implementation, the API reference extraction process may utilize keyword-based queries, semantic search algorithms, or hierarchical navigation of documentation indices to locate relevant entries. For example, upon identifying the use of N/record.getCurrentLineValue, the process may search for module-level documentation on N/record, followed by method-level documentation on getCurrentLineValue, and finally cross-reference parameter details for sublistId and fieldId. If the example code includes ambiguous or overloaded method names, the extraction may consult execution context and script type constraints to further refine the search, ensuring only contextually valid API references are retrieved.

Alternative embodiments of the API reference extraction process may incorporate relational database queries, knowledge graph traversal, or machine learning-based document ranking to optimize relevance and accuracy. For extensibility, the process can be adapted to aggregate documentation from multiple sources, reconcile differences between versions, or prioritize official over community-generated entries. In environments with sparse documentation, the process may utilize code mining techniques or collaborative curation to supplement missing references.

The output of the API reference extraction process is a structured set of documentation entries (extracted references 540), each mapped to the corresponding script type, module, or method used in the code sample. This mapping is useful for subsequent filtering and augmentation steps, as it ensures that every code generation example can be paired with authoritative API knowledge, thereby minimizing errors and reinforcing best practices in model training.

A notable challenge arises when multiple methods in the target programming language (e.g., SuiteScript) share similar names but belong to different modules, potentially leading to ambiguity in code generation. To address this, the knowledge augmentation subsystem 520 executes an API reference filtering process using a generative model (e.g., an LLM). The API reference filtering process may be considered a refinement stage within the knowledge augmentation framework 500, designed to disambiguate and select the most contextually appropriate API methods from among multiple candidates identified during the prior extraction process.

To illustrate the API reference filtering process, consider a SuiteScript 2.x code example that imports the N/record module and calls a method named getCurrentLineValue. Suppose that, within the curated API documentation, both N/record and another module, say N/currentRecord, define methods with similar names getCurrentLine Value and getCurrentSublistValue. Conventional retrieval processes may surface both methods, but only one is correct and contextually valid for the code example at hand.

In various embodiments, the filtering process operates as follows: The previously extracted knowledge 535 (script type, module imports, entry points, and method calls) are input into a generative model, along with the candidate API documentation entries (extracted references 540). The generative model is prompted to analyze the code context and documentation, and to select the API method that best fits the intended operation. For example, the prompt may ask the model to “identify which of the following methods is appropriate for retrieving the value of a field in the ‘partners’ sublist in a SuiteScript 2.x ClientScript, and explain its role in the code.” The generative model, drawing on its trained representation of SuiteScript conventions and its understanding of module contexts, will reason that N/record.getCurrentLine Value is the correct method if the code operates on a record object in a client script, and will generate a concise role description such as “retrieves the value of a specified field from the current line in the ‘partners’ sublist of the active record.”

The generative model may also be tasked with filtering out irrelevant or incorrectly scoped methods, such as those belonging to modules not imported in the code or methods not supported by the identified script type. In cases where multiple methods could be valid, the generative model can provide ranked recommendations, confidence scores, or explanatory notes to assist downstream augmentation or human review. For further robustness, the filtering process may be iterative, with the generative model reevaluating selections as additional context or documentation is provided. For example, if the code sample is ambiguous or includes dynamic module loading, the generative model can be prompted to consider alternative scenarios or fallback recommendations.

Alternative embodiments of the API reference filtering process may employ rule-based classifiers, decision trees, or hybrid systems combining machine reasoning with manual validation. Filtering criteria may include script type compatibility, parameter requirements, module dependencies, or historical usage patterns mined from code repositories. For extensibility, the filtering logic can be adapted to other languages or frameworks by retraining the generative model or incorporating domain-specific heuristics.

In some implementations, the filtering process may be integrated with a feedback mechanism, whereby model selections are periodically validated against actual code execution or expert review, and corrections are incorporated into the generative model's prompt engineering or training regimen. This ensures continuous improvement and adaptation to evolving API conventions.

The output of the API reference filtering process is a refined set of API method references, each paired with a contextually accurate role description and, optionally, confidence metadata. This filtered set is then used in training example augmentation, ensuring that every code generation prompt and solution is grounded in the most relevant, authoritative, and context-appropriate API knowledge.

Once the relevant API references have been identified, the knowledge augmentation subsystem 520 executes an instance augmentation process 545. This is comprised of two complementary strategies. First, prompts for code tasks are explicitly augmented with instructions requiring the generation of API method descriptions, priming the model to incorporate API context during code tasks such as code generation. Second, the gold-standard solutions for each prompt are augmented by appending the relevant API methods and their role descriptions at the beginning, using a RAG process. This ensures that every training example tightly couples code logic with the correct API reference, instilling authoritative usage patterns into the model's learned representation. Instance augmentation can be performed at varying levels of granularity, such as modifying only prompts, only solutions, or both. The RAG process may be implemented using dense vector retrieval, BM25, transformer-based retrievers, or other techniques as appropriate, and further augmentation may include metadata such as parameter validation rules or illustrative usage examples.

To illustrate the instance augmentation process 545, consider the following prompt for a SuiteScript 2.x code generation task where the prompt is explicitly augmented with instructions requiring the generation of API method descriptions:
“Create a SuiteScript 2.x module that handles queue processing for PDF and email queues. The module should:
Clean parameters by removing unnecessary fields before redirecting to a Suitelet.
Handle queue processing by retrieving paged data, building a form, and writing the form to the response.
Support OneWorld (OW) feature and logging.
   The module should be designed to work with both PDF and email queues, and should handle pagination and filtering.
   Before generating the code, generate SuiteScript 2.x API methods that would be used for the coding problem following the format [SuiteScript 2.x API method]: [description of method role in solving the problem].”

The gold-standard solutions for each prompt are augmented by appending the relevant API methods and their role descriptions at the beginning. For example, the following API reference may be prepended to a gold label solution for a code generation example, providing the model with direct access to the semantics and usage patterns of each method required for the task:

```
- url.resolveScript(options): Resolves the script URL for the suitelet deployment.
- runtime.isFeatureInEffect(options): Checks if the ‘subsidiaries’ feature is in effect.
- log.debug(options): Logs a debug message with the value of ‘isOW’.
- ServerResponse.writePage(options): Writes the form to the response page.
‘javascript
/
*@NApiVersion 2.x
*@NScriptType Suitelet
*/
define([′N/runtime′, ′N/url′, ′N/cache′, ′N/log′, ′N/record′, ′N/search′], function (nRuntime, nUrl,
cache, log, record, search) {
  var C = {
    QUEUE_MODULE: { PARAM: { ACTION: ′action′, PAGE: ′page′, IDS: ′ids′,
FILTER_PARAM: { TYPE: ′type′, URL: ′url′ } }, SUITELET: { SCRIPT: ′suitelet_script_id′,
DEPLOYMENT: { PDF: ′pdf_deployment_id′, EMAIL: ′email_deployment_id′ } } },
  MODULE: { FILTER_PARAM: { URL: ′url′, TYPE: ′type′, SIZE: ′size′ }, SUITELET: {
SCRIPT: ′suitelet_script_id′, DEPLOYMENT: { PDF: ′pdf_deployment_id′, EMAIL:
′email_deployment_id′ } } },
  MAX_PAGE_SIZE: 50 }; function cleanParams(params) { delete
params[C.QUEUE_MODULE.PARAM.ACTION]; delete
params[C.QUEUE_MODULE.PARAM.PAGE]; delete
params[C.QUEUE_MODULE.PARAM.IDS]; delete
params[C.QUEUE_MODULE.FILTER_PARAM.TYPE]; delete
params[C.QUEUE_MODULE.FILTER_PARAM.URL]; return params; } function
onRequest(context) { var request = context.request; var response =
context.response; var params = request.parameters; var isPdfQueue =
request.isPdfQueue( ); request.onProcess.push(cleanParams); request.onRemove.push(cl
eanParams); request.onDefault.push(function ( )
{ params[C.MODULE.FILTER_PARAM.URL] = nUrl.resolveScript({ scriptId:
C.MODULE.SUITELET.SCRIPT, deploymentId: isPdfQueue ?
C.MODULE.SUITELET.DEPLOYMENT.PDF :
C.MODULE.SUITELET.DEPLOYMENT.EMAIL }); params[C.MODULE.FILT
ER_PARAM.TYPE] = isPdfQueue ? ′pdf′ : ′email′; var except =
cache.getLockedResults( ); var pageSize = params[C.MODULE.FILTER_PARAM.SIZE]
∥ C.MAX_PAGE_SIZE; var pagedData = isPdfQueue ? results.pdfQueue(params,
pageSize, except) : results.emailQueue(params, pageSize, except); var isOW =
nRuntime.isFeatureInEffect({ feature: ′subsidiaries′ }); log.debug(′is OW : ′ +
isOW); var pageNumber = parseInt(params[C.MODULE.FILTER_PARAM.PAGE], 10)
∥ 1; var form = formBuilder.buildForm(params, pagedData, pageNumber, pageSize,
!isPdfQueue, isOW); response.writePage(form); }); request.handle( ); } return
{ onRequest: onRequest };});‘
```

In this code, the explicitly referenced API methods play distinct and important roles as described in the initial API reference. url.resolveScript is used to dynamically determine the appropriate Suitelet deployment URL based on queue type; runtime.isFeatureInEffect checks whether the account has the OneWorld feature enabled for subsidiary support; log.debug records diagnostic information about the queue's state; and ServerResponse.writePage outputs the constructed form to the browser interface.

By embedding these API references and descriptions directly within both the prompt and the gold label solution, the instance augmentation process ensures that the model to be fine-tuned is consistently exposed to authoritative, context-specific API usage. This explicit linkage between code logic and API documentation may be accomplished programmatically, for example using a RAG mechanism that maps each code component to its corresponding documentation entry.

Alternative embodiments of the instance augmentation process may vary in scope and complexity, for example by including parameter validation rules, usage examples, governance notes, or compatibility constraints in the API reference section. The RAG mechanism may employ different retrieval algorithms, such as semantic search or transformer-based retrievers, depending on the structure and scale of the API corpus. Both the prompt and solution can be further enriched with metadata, such as version constraints, deprecation warnings, or links to extended documentation, to reinforce best practices and ensure up-to-date model knowledge.

Through this augmentation process grounded in explicit API references, role descriptions, and authoritative documentation the knowledge augmentation subsystem 520 provides a bridge between practical coding tasks and the curated API knowledge base. This enables the fine-tuned generative model to perform code tasks that are both syntactically correct and semantically aligned with best practices, dramatically reducing the risk of hallucinated or misapplied methods in automated code generation for SuiteScript and other low-resource programming languages.

Consequently, each of the augmented training examples output by the knowledge augmentation subsystem 520 via the instance augmentation process is comprised of a prompt that requests a generative model to perform a given code task, along with the corresponding gold label solution (the relevant API methods and their role descriptions). More specifically, the augmented training examples are constructed as duplets in the form of <x_prompt, y_c>:
x_prompt: The prompt for performing the given code task.
y_c: The completion from performing the given code task.

In some implementations, the augmented training examples may be generated by associating the prompt including instruction for the given code task with the completion (e.g., code snippet extracted from the code files) and storing the duplets and association in a data store, table and/or matrix as a data set. In some implementations, the augmented training examples may be generated by labelling a prompt including instruction for the given code task as an input and labelling a corresponding completion as an output to create an input-output pair. Consequently, each of the augmented training examples contains a prompt including instruction for the given code task and a corresponding completion.

These augmented training examples are then added to a pool of training examples (supervised fine-tuning data) stored in SFT example repositories 515, along with the original code generation training examples from the code training data repositories 505.

The knowledge test build subsystem 525 utilizes knowledge or information within documents stored in knowledge repositories 510 to generate different types of pairs of prompts comprising questions 550 and answers 555 from corresponding documentation using an instance synthesis process 560. For example, pairs of questions 550 and answers 555 may be generated by synthesis process 560 for the general description of aspects of a target programming language such as general descriptions of script types, modules, and methods. For one or more script types, modules, and/or methods, a generative model may be prompted to generate a description (question) and the gold label response (answer) is the description from the corresponding documentation. Additionally or alternatively, pairs of questions and answers may be generated by synthesis process 560 for the matching description of aspects of a target programming language such as name of script types, entry points, modules, and methods. For one or more script types, entry points, modules, and/or methods, a generative model may be prompted to identify or generate a name of a script type, entry point, module, or method matching or corresponding to a given description (question) and the gold label response (answer) is the name of script type, entry point, module, or method from the corresponding documentation. Additionally or alternatively, pairs of questions and answers may be generated by synthesis process 560 for corresponding aspects or properties of a target programming language such as corresponding script type for an entry point or corresponding entry point for a method. To enforce relationships between script types and entry points, a generative model may be prompted to identify or generate the corresponding script for a given entry point (question) and the gold label response (answer) is the corresponding script from the corresponding documentation. Similarly, to enforce relationships between methods and modules, a generative model may be prompted to identify or generate the corresponding entry point for a given method (question) and the gold label response (answer) is the corresponding entry point from the corresponding documentation. Additionally or alternatively, a generative model may be prompted to list valid methods for a module (question) and the gold label response (answer) is the valid methods from the corresponding documentation; and/or to identify valid parameters for a method (question) and the gold label response (answer) is the valid parameters from the corresponding documentation. Additionally or alternatively, pairs of questions and answers may be generated for corresponding aspects of a target programming language such as corresponding script type for an entry point or corresponding entry point for a method.

More specifically, knowledge test build subsystem 525 may be configured to build a foundational, factual knowledge base of synthetic training examples (pairs of prompts with a question and gold label response) by directly associating an API component's canonical name with its detailed documentation. To generate a synthetic training example of this type, a specific API component such as a script type (e.g., BundleInstallationScript), a module (e.g., N/action), or a method (e.g., Action (options)) is selected. A direct question for the prompt is then programmatically formulated by the knowledge test build subsystem 525 using a standardized template, for instance, “Generate SuiteScript 2.x API reference for [component name].” The prompt (see examples below in Table 4) can be generated using one or more generative models or a structured approach such as templates and slot filling. A template serves as a pre-defined framework or skeleton, containing placeholders (or “slots”) where specific information (e.g., component name) can be inserted dynamically. These slots represent variables or key elements that are tailored to the specific context or question at hand. By combining a flexible template with targeted slot filling, prompts can be automatically generated in a consistent, accurate, and efficient manner. This method reduces the cognitive load of manually crafting prompts, ensures the inclusion of all required details, and enhances the precision of the generative model's response by providing it with clear, structured input. As should be understood, other prompts discussed herein such as the matching description prompt and the properties prompt can be generated using similar techniques as described below. The corresponding “gold label response” is a structured, comprehensive excerpt extracted directly from the authoritative API documentation. This answer is not merely a brief definition but includes the details such as the component's formal name, a complete functional description, a list of valid entry points or parameters, supported script types, and parent objects, thereby creating a rich, factual record that serves as the ground truth for the model.

TABLE 4
Example Prompt Template and Sample (question) and output Sample (gold response):

| Prompt | Prompt Sample | |
|---|---|---|
| Template | (question) | Output Sample (gold answer) |
| Generate SuiteScript | Generate | Name: BundleInstallationScript |
| 2.x API | SuiteScript | Description: Bundle installation scripts are specialized server |
| reference for <script | 2.x API | scripts that perform processes in target accounts as part of a |
| type> | reference for | bundle installation, update, or uninstallation. These processes |
| Output format: Name: | SuiteScript | include setup, configuration, and data management tasks that |
| script type name | 2.x Bundle | would otherwise have to be completed by account administrators. |
| in suitescript code | Installation | Entry points: afterInstall(params) - defines the function that |
| Description: | Script Type | executes after a bundle is installed for the first time in a target |
| . . . | Output format: | account. afterUpdate(params) - defines the function that |
| Entry Points: | Name: script | executes after a bundle in a target account is updated. |
| list of entry | type name in | beforeInstall(params) - defines the function that executes |
| points without | suitescript code | before a bundle is installed for the first time in a target |
| description as | Description: | account. beforeUninstall(params) - defines the function that |
| entrypoint1, | . . . | executes before a bundle is uninstalled from a target account. |
| entrypoint2, | Entry Points: | beforeUpdate(params) - defines the function that executes |
| . . . | list of entry | before a bundle in a target account is updated. Entry Points: |
| | points without | afterInstall(params), afterUpdate(params), beforeInstall(params), |
| | description as | beforeUninstall(params), beforeUpdate(params) |
| | entrypoint1, | |
| | entrypoint2, | |
| | . . . | |
| Generate SuiteScript | Generate | Name: BundleInstallationScript |
| 2.x API | SuiteScript | Description: Bundle installation scripts are specialized server |
| reference for | 2.x API | scripts that perform processes in target accounts as part of a |
| <module> | reference for | bundle installation, update, or uninstallation. These processes |
| Output format: | SuiteScript | include setup, configuration, and data management tasks that |
| Name: script type | 2.x Bundle | would otherwise have to be completed by account administrators. |
| name in suitescript | Installation | Entry points: afterInstall(params) - defines the function that |
| code | Script Type | executes after a bundle is installed for the first time in a target |
| Description: | Output format: | account. afterUpdate(params) - defines the function that |
| . . . | Name: script type | executes after a bundle in a target account is updated. |
| Entry Points: list of | name in suitescript | beforeInstall(params) - defines the function that executes |
| entry points without | code | before a bundle is installed for the first time in a target |
| description as | Description: | account. beforeUninstall(params) - defines the function that |
| entrypoint1, | . . . | executes before a bundle is uninstalled from a target account. |
| entrypoint2, | Entry Points: list | beforeUpdate(params) - defines the function that executes |
| . . . | of entry points | before a bundle in a target account is updated. Entry Points: |
| | without | afterInstall(params), afterUpdate(params), beforeInstall(params), |
| | description as | beforeUninstall(params), beforeUpdate(params) |
| | entrypoint1, | |
| | entrypoint2, | |
| | . . . | |

To move beyond simple recall and instill a deeper comprehension of the API's semantics, knowledge test build subsystem 525 may be configured to generate “Matching Description” pairs. This technique effectively inverts the logic of the General Description pairs. Instead of providing a name and asking for a description, the process begins by extracting the descriptive text of an API component from the documentation. This descriptive text is then embedded into a prompt template (see examples below in Table 5) that instructs a generative model to identify the specific component that matches the given functionality, such as, “Identify a SuiteScript 2.x Script Type to match the Description.” The correct “gold label response” is the precise name of the corresponding component (e.g., SuiteScript 2.x Script Type: Bundle Installation). This method forces the generative model to analyze and understand the functional role and context of a component based solely on its description, thereby training it to map a desired outcome or behavior to the correct API syntax, which is an important skill for accurately interpreting user prompts and reducing API misuse.

TABLE 5
Example Prompt Template and Sample (question) and output Sample (gold response):

| Prompt Template | Prompt Sample (question) | Output Sample (gold answer) |
|---|---|---|
| Description: | Description: scripts are specialized | SuiteScript 2.x Script Type: Bundle |
| <script type | server scripts that perform processes | Installation |
| description> | in target accounts as part of a, update, | |
| Instruction: | or uninstallation. these processes | |
| Identify a | include setup, configuration, and data | |
| SuiteScript | management tasks that would | |
| 2.x Script Type | otherwise have to be completed by | |
| to match the | account administrators. entry points: | |
| Description | afterinstall(params) - defines the | |
| Output format: | function that executes after a bundle is | |
| SuiteScript | installed for the first time in a target | |
| 2.x Script | account. afterupdate(params) - | |
| Type: | defines the function that executes | |
| Script_Type | after a bundle in a target account is | |
| SuiteScript | updated. beforeinstall(params) - | |
| 2.x Script | defines the function that executes | |
| Type: Bundle | before a bundle is installed for the | |
| Installation | first time in a target account. | |
| | beforeuninstall(params) - defines the | |
| | function that executes before a bundle | |
| | is uninstalled from a target account. | |
| | beforeupdate(params) - defines the | |
| | function that executes before a bundle | |
| | in a target account is updated. | |
| | Instruction: Identify a SuiteScript 2.x | |
| | Script Type to match the Description | |
| | Output format: | |
| | SuiteScript 2.x Script Type: | |
| | Script_Type | |
| Description: | Description: Defines the function that | SuiteScript 2.x Entry Point: afterInstall |
| <entry point | is executed after a bundle is installed | (params) |
| description> | for the first time in a target account. | |
| Instruction: Identify | Instruction: Identify SuiteScript 2.x | |
| SuiteScript | Entry Point to match the Description | |
| 2.x Entry Point to | Output format: | |
| match the Description | SuiteScript 2.x Entry Point: | |
| Output format: | entry_point | |
| SuiteScript | | |
| 2.x Entry Point: | | |
| entry_point | | |

Another important aspect of API correctness is understanding the structural and hierarchical relationships between different components; for example, methods belong to specific modules, and entry points are valid only for certain script types. To teach a generative model these architectural rules, the knowledge test build subsystem 525 generates question-answer pairs focused on “API properties.” These questions are explicitly designed to query the relational links between components. For instance, a question might be, “What is the script type of the Suitescript 2.x Entry Point afterInstall(params)?” or “What is SuiteScript 2.x Module for Suitescript 2.x Method Action (options)?” The questions are then embedded into a prompt template (see examples below in Table 6) that instructs the generative model to generate the corresponding script type for an entry point and/or the corresponding entry point for a method. The gold label responses for these questions are direct, factual statements of the relationship (e.g., BundleInstallationScript or N/action), which are derived from the structured nature of the API documents. This training forces the generative model to learn the valid associations and dependencies within the API framework, which is useful for preventing the generation of structurally flawed code, such as calling a method from a module that has not been imported or is inappropriate for the context.

TABLE 6
Example Prompt Template and Sample (question)
and output Sample (gold response):

| | Prompt Sample | |
|---|---|---|
| Prompt Template | (question) | Output Sample (gold answer) |
| What is the script | What is the script | SuiteScript 2.x Entry Point |
| type of the Suitescript | type of the | afterInstall(params) Script |
| 2.x Entry Point <entry | Suitescript 2.x | Type: BundleInstallationScript |
| point> | Entry Point | |
| Output format: | afterInstall | |
| Suitescript 2.x | (params) | |
| Entry Point | Output format: | |
| <entry point> | Suitescript 2.x | |
| Script Type: | Entry Point | |
| script_type | afterInstall | |
| | (params) | |
| | Script Type: | |
| | script_type | |
| What is SuiteScript | What is | SuiteScript 2.x Module: |
| 2.x Module for | SuiteScript 2.x | N/action |
| Suitescript 2.x | Module for | |
| Method <method | Suitescript 2.x | |
| name> | Method Action | |
| Output format: | (options) | |
| SuiteScript 2.x | Output format: | |
| Module: Module | SuiteScript 2.x | |
| | Module: Module | |

Finally, to address API inaccuracy and hallucination at the most granular level, the knowledge test build subsystem 525 generates question-answer pairs that compel a generative model to learn the precise and complete set of attributes for a given API component. This is achieved by formulating questions that demand an exhaustive list of a component's members, such as, “List all valid SuiteScript 2.x Method(s) from N/action Module” or “List all valid parameters of SuiteScript 2.x Method Action (options).” The questions are then embedded into a prompt template (see examples below in Table 7) that instructs the generative model to generate the corresponding list of a component's members. The corresponding gold label response is a comprehensive enumeration of these members (e.g., a list of all methods within the module or the specific names and types of a method's parameters) sourced directly from the API documentation. By repeatedly training on these complete and definitive lists, the generative model learns the exact boundaries of an API component's functionality. This process minimizes the tendency to invent non-existent methods or properties and ensures that when a known method is used, it is called with the correct parameters, thereby ensuring the generated code is not only structurally sound but also syntactically precise.

TABLE 7
Example Prompt Template and Sample (question) and output Sample (gold response):

| | Prompt Sample | |
|---|---|---|
| Prompt Template | (question) | Output Sample (gold answer) |
| List all valid | List all valid | N/action Module Methods: Action(options), |
| SuiteScript 2.x | SuiteScript 2.x | Action.description, Action.execute(options), |
| Method(s) from | Method(s) from N/ | Action.execute.promise(options), |
| <module name> | action Module | Action.executeBulk(options), Action.id, Action.label, |
| Output format: | Output format: | Action.parameters, Action.promise (options), |
| <module name> | N/action Module | Action.recordType, action.Action, action.execute(options), |
| Methods: list of | Methods: list of | action.execute.promise(options), |
| methods without | methods without | action.executeBulk(options), action.find(options), |
| description as | description as | action.find.promise(options), action.get(options), |
| method1, | method1, | action.get.promise (options), |
| method2, . . . | method2, . . . | action.getBulkStatus(options) |
| List all valid | List all valid | Action(options) Parameters: Object, recordId |
| parameters of | parameters of | |
| SuiteScript 2.x | SuiteScript 2.x | |
| Method <method | Method Action | |
| name> | (options) | |
| Output format: | Output format: | |
| <method name> | Action(options) | |
| Parameters: | Parameters: | |
| parameter1, | parameter1, | |
| parameter2, . . . | parameter2, . . . | |

Consequently, each of the synthetic training examples output by the knowledge test build subsystem 525 via the knowledge instillation process is comprised of a prompt that requests a generative model to generate an answer to a question, along with the corresponding gold label response (answer). More specifically, the synthetic training examples are constructed as duplets in the form of <x_prompt, y_c>:
prompt: The prompt with a question.
y_c: The completion or answer to the question.

In some implementations, the synthetic training examples may be generated by associating the prompt including instruction for answering a question with the completion (e.g., answer extracted from the documentation) and storing the duplets and association in a data store, table and/or matrix as a data set. In some implementations, the synthetic training examples may be generated by labelling a prompt including instruction for answering a question as an input and labelling a corresponding completion or answer as an output to create an input-output pair. Consequently, each of the augmented training examples contains a prompt including instruction for the given code task and a corresponding completion.

These synthetic training examples are then added to a pool of training examples (supervised fine-tuning data) stored in SFT example repositories 515, along with the original code generation training examples from the one or more code training data repositories 505 and the augmented training examples generated by the knowledge augmentation subsystem 520.

After being processed by the knowledge augmentation subsystem 520 and/or the knowledge test build subsystem 525, a final fine-tuning data set (stored in SFT example repositories 515) comprised of training examples from: the original code generation training examples from the one or more code training data repositories 505, the augmented training examples from the knowledge augmentation subsystem 520, the synthetic training examples from the knowledge test build subsystem 525, or any combination thereof is provided for model training or fine-tuning by the model fine-tuner 530. In some aspects, the models being trained or fine-tuned by the model fine-tuner 530 may be smaller (i.e., have a smaller number of parameters such as Qwen2-72B-Instruct or Llama-3.1-70B-Instruct) than the one or more generative models used by the knowledge augmentation subsystem 520 and/or the knowledge test build subsystem 525. In such instances, advantageously, a generative model (e.g., the smaller or base LLM) can be trained or fine-tuned with the training examples to meet user needs and deployed within a code service environment without the associated computational and latency costs of deploying a large generative model.

The model training or fine-tuning performed by the model fine-tuner 530 is described in detail with respect to FIG. 4 and generates one or more fine-tuned machine learning models 565. A fine-tuned machine learning model refers to a pre-trained model (e.g., a pre-trained machine learning model or generically referred to herein in some instances as a machine learning model) that has been further trained or adapted to perform well on a specific task or domain (e.g., code generation, completion, explanation, documentation or unit test generation using a given target programming language). The process typically involves taking a general-purpose model that has already been trained on a broad data set and refining it using a smaller, task-specific data set (e.g., the final fine-tuning data set). Fine-tuning can include adjusting the parameters of a pre-trained model by performing additional training using training examples (e.g., the final fine-tuning data set) for a specific task or domain such as code documentation. The qualities or characteristics that make a model fine-tuned may include: adjusted to address a particular problem, use case, or domain, retains the foundational knowledge learned during its initial pre-training while adapting to the specific task or programming language, fine-tuned model demonstrates better accuracy, relevance, or effectiveness in the specific task or programming language compared to the original pre-trained model, the model's outputs are tailored to the language, structure, or requirements of the specific domain or task, weights and biases (model parameters) of the model are updated during fine-tuning to optimize performance for the specific task or programming language, while avoiding overfitting to the smaller fine-tuning data set, learn nuances specific to the task or field for which it is fine-tuned, or any combination thereof. The model fine-tuner 530 may fine-tune one or more generative models to generate the one or more fine-tuned machine learning models 565. Lastly, hyper-parameter tuning may be performed to select the model that performs best on the final fine-tuning data set, which may be deployed in a production environment (e.g., code model 222 of FIG. 2 or code model 422 of FIG. 4).

### Illustrative Methods

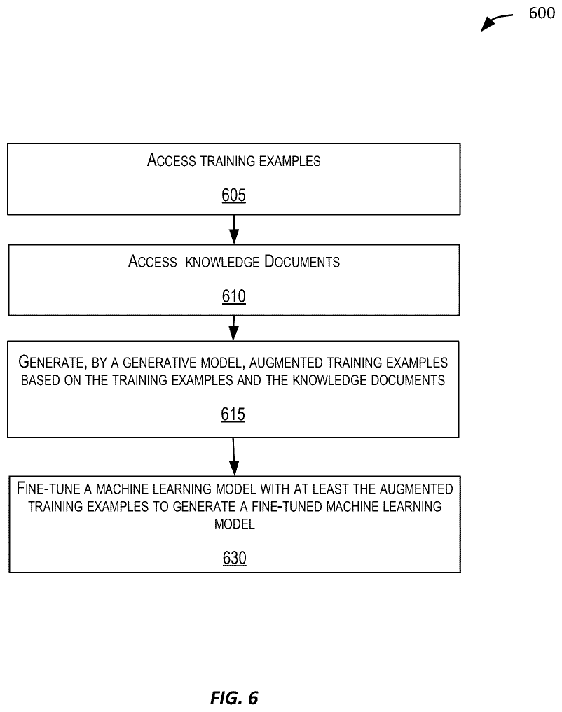

FIG. 6 is a flowchart illustrating a process 600 for generating a fine-tuning data set including augmented and/or synthesizing training examples to train a machine learning model for performance of one or more code tasks using a target programming language, according to various embodiments. The processing depicted in FIG. 6 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 6 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-5, the processing depicted in FIG. 6 may be performed by framework 500, as described with respect to FIG. 5, and/or a training, testing, and deployment or production system or subsystem, as described with respect to FIGS. 1-4.

At step 605, training examples are accessed. Each of the training examples comprises: (i) a prompt including a code task to be performed using a target programming language, and (ii) a completion including a gold code solution associated with performance of the code task.

At step 610, a documentation dataset comprising references for components of the target programming language is accessed.

In some instances, the target programming language is a low-resource programming language, the documentation dataset is an API documentation dataset, and the components of the low-resource programming language include one or more script types, one or more modules, one or more methods, one or more entry points, or any combination thereof.

In some instances, for each training example in the training examples: (i) extracting a subset of components from the completion of the training example using a rule-based process; (ii) extracting documentation related to the extracted subset of components from the documentation dataset; and (iii) filtering, by a generative model, the extracted subset of components and the extracted documentation to extract one or more components of the target programming language and role descriptions of the one or more components.

At step 615, generating, by a generative model based on the training examples and the documentation dataset, augmented training examples. Each of the augmented training examples comprises: (i) an augmented prompt including instructions to generate a description of one or more of the components of the target programming language and the code task to be performed using the target programming language, and (ii) an augmented completion including: the one or more components of the target programming language, role descriptions of the one or more components that are extracted directly from the documentation dataset, and the gold code solution.

At step 620, a pre-trained machine learning model is fine-tuned with at least the augmented training examples to generate a fine-tuned machine learning model.

In some instances, prior to fine-tuning, synthetic training examples are generated by a generative model and/or a structured programmatic process based on the documentation dataset. Each of the synthetic training examples comprises: (i) a synthetic prompt including a question associated with one or more of the components of the target programming language, and (ii) a synthetic completion including an answer to the question that is extracted directly from the documentation dataset. In such an instance, the fine-tuning the pre-trained machine learning model is performed with at least the augmented training examples and the synthetic training examples to generate the fine-tuned machine learning model.

In some instances, for each training example in the training examples: (i) extracting a subset of components from the completion of the training example using a rule-based process, wherein the subset of components comprises script types, modules, methods, and entry points of the target programming language; (ii) extracting API documentation related to the script types, the modules, the methods, and the entry points from the documentation dataset; and (iii) filtering, by a generative model, the extracted subset of components and the extracted documentation to select relevant script types, modules, methods, entry points, or any combination thereof from the script types, the modules, the methods, and the entry points and the role descriptions of the selected relevant script types, the selected relevant modules, the selected relevant methods, the selected relevant entry points, or the selected any combination thereof. Each of the augmented training examples comprises: (i) an augmented prompt including the instructions to generate, before generating a predicted code solution to the code task, a description of the selected relevant script types, the selected relevant modules, the selected relevant methods, the selected relevant entry points, or the selected any combination thereof and the code task to be performed using the target programming language, and (ii) an augmented completion including: the selected relevant script types, the selected relevant modules, the selected relevant methods, the selected relevant entry points, or the selected any combination thereof, role descriptions of the selected relevant script types, the selected relevant modules, the selected relevant methods, the selected relevant entry points, or the selected any combination thereof, and the gold code solution.

In some instances, for each training example in the training examples: (i) extracting a subset of components from the completion of the training example using a rule-based process, wherein the subset of components comprises script types, modules, methods, and entry points of the target programming language; (ii) extracting API documentation related to the script types, the modules, the methods, and the entry points from the documentation dataset; and (iii) filtering, by a generative model, the extracted subset of components and the extracted documentation to select one or more relevant methods, from the methods and the role descriptions of the selected one or more relevant modules. Each of the augmented training examples comprises: (i) an augmented prompt including the instructions to generate, before generating a predicted code solution to the code task, a description of the selected one or more relevant modules and the code task to be performed using the target programming language, and (ii) an augmented completion including: the selected one or more relevant modules, role descriptions of the selected one or more relevant modules, and the gold code solution.

In some instances, process 600 further comprises: receiving an input from a user, the input comprising a natural language component; converting the input into a prompt, wherein the prompt comprises an instruction, a code snippet associated with the natural language component, and an utterance associated with the natural language component, and wherein the utterance includes a request to perform the code task using or based on the target programming language; transmitting the prompt to the fine-tuned machine learning model; receiving, from the fine-tuned machine learning model, a predicted code solution corresponding to execution of the code task based at least in part on the prompt; and providing the predicted code solution to the user.

In some instances, the generative models described with respect to process 600 are all the same model (e.g., implemented by different model calls to a same model), are all different models (e.g., implemented by different model calls to different models), or a subset of the models are the same model(s) as another subset of the models or a subset of the models are different model(s) from another subset of the models (e.g., implemented by different model calls to same or different models).

### Illustrative System

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

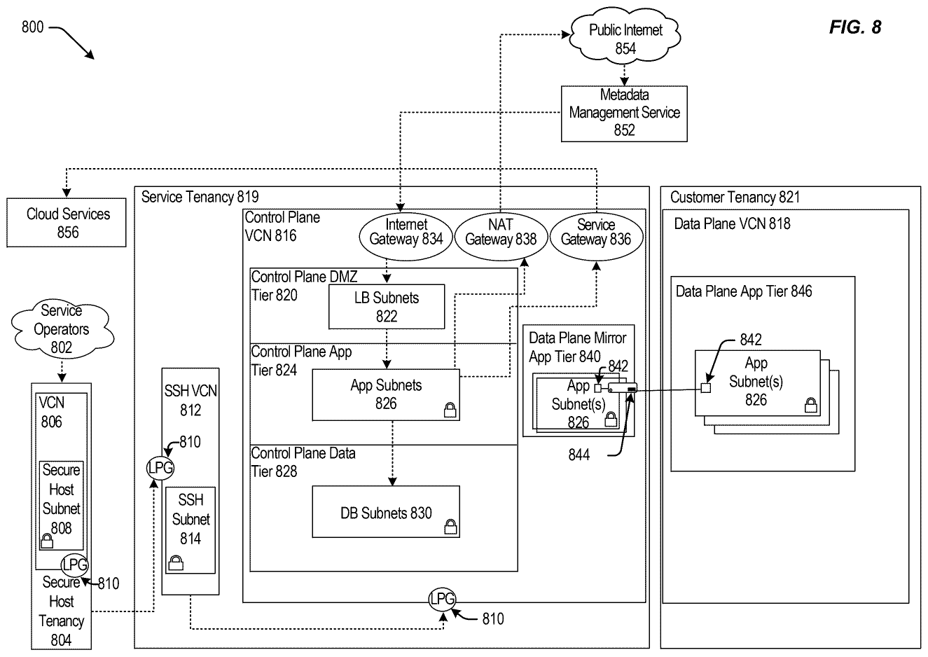

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

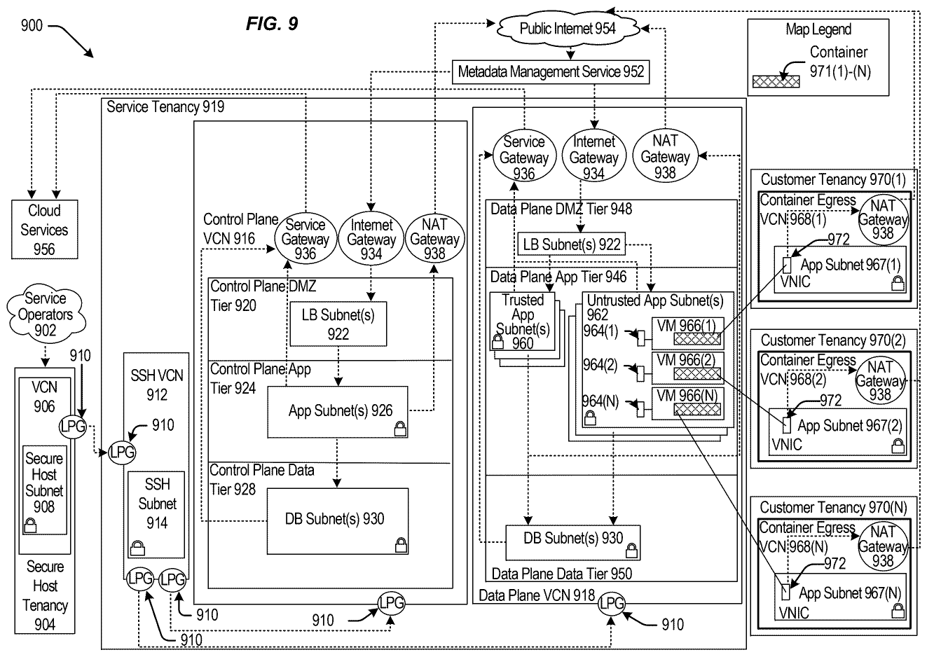

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

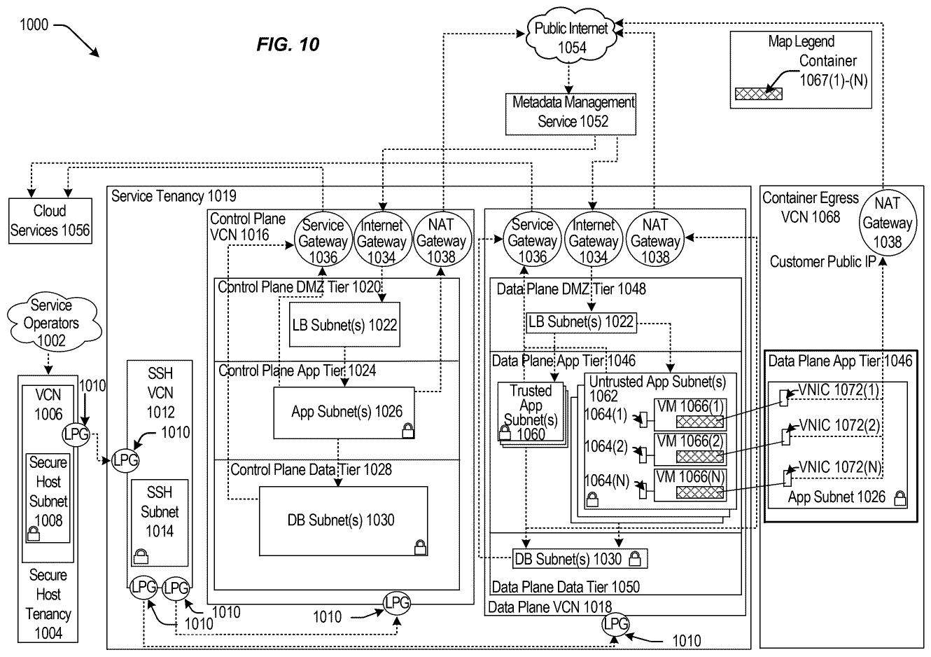

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

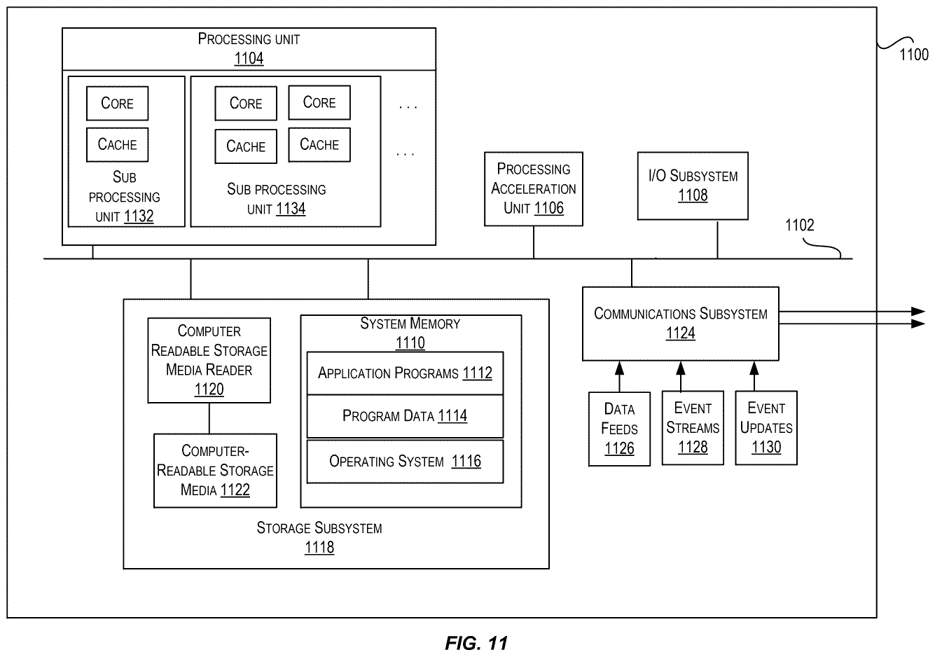

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing training examples, wherein each of the training examples comprises: (i) a prompt including a code task to be performed using a target programming language, and (ii) a completion including a gold code solution associated with performance of the code task;
accessing a documentation dataset comprising references for components of the target programming language;
generating, by a generative model based on the training examples and the documentation dataset, augmented training examples, wherein each of the augmented training examples comprises: (i) an augmented prompt including instructions to generate a description of one or more of the components of the target programming language and the code task to be performed using the target programming language, and (ii) an augmented completion including: the one or more components of the target programming language, role descriptions of the one or more components that are extracted directly from the documentation dataset, and the gold code solution; and
fine-tuning a pre-trained machine learning model with at least the augmented training examples to generate a fine-tuned machine learning model.

2. The computer-implemented method of claim 1, further comprising:
generating, by a generative model and/or a structured programmatic process based on the documentation dataset, synthetic training examples, wherein each of the synthetic training examples comprises: (i) a synthetic prompt including a question associated with one or more of the components of the target programming language, and (ii) a synthetic completion including an answer to the question that is extracted directly from the documentation dataset;
wherein the question includes: (i) a request to generate a description for the one or more components, (ii) a request to identify a name of the one or more components based on a description of the one or more components, (iii) a request to identify one or more related components corresponding to the one or more components, or any combination of (i)-(iii);
wherein the answer, based on the question, includes: (i) the description for the one or more components, (ii) the name of the one or more components, (iii) the one or more related components corresponding to the one or more components, or any combination of (i)-(iii); and
wherein the fine-tuning the pre-trained machine learning model is performed with at least the augmented training examples and the synthetic training examples to generate the fine-tuned machine learning model.

3. The computer-implemented method of claim 1, wherein the target programming language is a low-resource programming language, the documentation dataset is an API documentation dataset, and the components of the low-resource programming language include one or more script types, one or more modules, one or more methods, one or more entry points, or any combination thereof.

4. The computer-implemented method of claim 1, further comprising, for each training example in the training examples:
(i) extracting a subset of components from the completion of the training example using a rule-based process;
(ii) extracting documentation related to the extracted subset of components from the documentation dataset; and
(iii) filtering, by a generative model, the extracted subset of components and the extracted documentation to extract the one or more components of the target programming language and the role descriptions of the one or more components.

5. The computer-implemented method of claim 1, further comprising, for each training example in the training examples:
(i) extracting a subset of components from the completion of the training example using a rule-based process, wherein the subset of components comprises script types, modules, methods, and entry points of the target programming language;
(ii) extracting API documentation related to the script types, the modules, the methods, and the entry points from the documentation dataset; and
(iii) filtering, by a generative model, the extracted subset of components and the extracted documentation to select relevant script types, modules, methods, entry points, or any combination thereof from the script types, the modules, the methods, and the entry points and the role descriptions of the selected relevant script types, the selected relevant modules, the selected relevant methods, the selected relevant entry points, or the selected any combination thereof,
wherein each of the augmented training examples comprises: (i) an augmented prompt including the instructions to generate, before generating a predicted code solution to the code task, a description of the selected relevant script types, the selected relevant modules, the selected relevant methods, the selected relevant entry points, or the selected any combination thereof and the code task to be performed using the target programming language, and (ii) an augmented completion including: the selected relevant script types, the selected relevant modules, the selected relevant methods, the selected relevant entry points, or the selected any combination thereof, role descriptions of the selected relevant script types, the selected relevant modules, the selected relevant methods, the selected relevant entry points, or the selected any combination thereof, and the gold code solution.

6. The computer-implemented method of claim 1, further comprising, for each training example in the training examples:
(i) extracting a subset of components from the completion of the training example using a rule-based process, wherein the subset of components comprises script types, modules, methods, and entry points of the target programming language;
(ii) extracting API documentation related to the script types, the modules, the methods, and the entry points from the documentation dataset; and
(iii) filtering, by a generative model, the extracted subset of components and the extracted documentation to select one or more relevant methods, from the methods and the role descriptions of the selected one or more relevant modules,
wherein each of the augmented training examples comprises: (i) an augmented prompt including the instructions to generate, before generating a predicted code solution to the code task, a description of the selected one or more relevant modules and the code task to be performed using the target programming language, and (ii) an augmented completion including:
the selected one or more relevant modules, role descriptions of the selected one or more relevant modules, and the gold code solution.

7. The computer-implemented method of claim 1, further comprising:
receiving an input from a user, the input comprising a natural language component;
converting the input into a prompt, wherein the prompt comprises an instruction, a code snippet associated with the natural language component, and an utterance associated with the natural language component, and wherein the utterance includes a request to perform the code task using or based on the target programming language;
transmitting the prompt to the fine-tuned machine learning model;
receiving, from the fine-tuned machine learning model, a predicted code solution corresponding to execution of the code task based at least in part on the prompt; and
providing the predicted code solution to the user.

8. A system comprising:
one or more processors; and
one or more computer-readable media storing instructions which, when executed by the one or more processors, cause the system to perform operations comprising:
accessing training examples, wherein each of the training examples comprises: (i) a prompt including a code task to be performed using a target programming language, and (ii) a completion including a gold code solution associated with performance of the code task;
accessing a documentation dataset comprising references for components of the target programming language;
generating, by a generative model based on the training examples and the documentation dataset, augmented training examples, wherein each of the augmented training examples comprises: (i) an augmented prompt including instructions to generate a description of one or more of the components of the target programming language and the code task to be performed using the target programming language, and (ii) an augmented completion including: the one or more components of the target programming language, role descriptions of the one or more components that are extracted directly from the documentation dataset, and the gold code solution;
generating, by a generative model and/or a structured programmatic process based on the documentation dataset, synthetic training examples, wherein each of the synthetic training examples comprises: (i) a synthetic prompt including a question associated with one or more of the components of the target programming language, and (ii) a synthetic completion including an answer to the question that is extracted directly from the documentation dataset; and
fine-tuning a pre-trained machine learning model with the training examples, the augmented training examples, and the synthetic training examples to generate a fine-tuned machine learning model.

9. The system of claim 8, wherein the target programming language is a low-resource programming language, the documentation dataset is an API documentation dataset, and the components of the low-resource programming language include one or more script types, one or more modules, one or more methods, one or more entry points, or any combination thereof.

10. The system of claim 8, wherein the operations further comprise, for each training example in the training examples extracting, by a generative model, the one or more components of the target programming language from a subset of components from the completion of the training example and the role descriptions of the one or more components from the documentation dataset.

11. The system of claim 8, wherein the operations further comprise, for each training example in the training examples:
(i) extracting a subset of components from the completion of the training example using a rule-based process;
(ii) extracting documentation related to the extracted subset of components from the documentation dataset; and
(iii) filtering, by a generative model, the extracted subset of components and the extracted documentation to extract the one or more components of the target programming language and the role descriptions of the one or more components.

12. The system of claim 8, wherein the operations further comprise, for each training example in the training examples:
(i) extracting a subset of components from the completion of the training example using a rule-based process, wherein the subset of components comprises script types, modules, methods, and entry points of the target programming language;
(ii) extracting API documentation related to the script types, the modules, the methods, and the entry points from the documentation dataset; and
(iii) filtering, by a generative model, the extracted subset of components and the extracted documentation to select relevant script types, modules, methods, entry points, or any combination thereof from the script types, the modules, the methods, and the entry points and the role descriptions of the selected relevant script types, the selected relevant modules, the selected relevant methods, the selected relevant entry points, or the selected any combination thereof,
wherein each of the augmented training examples comprises: (i) an augmented prompt including the instructions to generate, before generating a predicted code solution to the code task, a description of the selected relevant script types, the selected relevant modules, the selected relevant methods, the selected relevant entry points, or the selected any combination thereof and the code task to be performed using the target programming language, and (ii) an augmented completion including: the selected relevant script types, the selected relevant modules, the selected relevant methods, the selected relevant entry points, or the selected any combination thereof, role descriptions of the selected relevant script types, the selected relevant modules, the selected relevant methods, the selected relevant entry points, or the selected any combination thereof, and the gold code solution.

13. The system of claim 8, wherein the operations further comprise, for each training example in the training examples:
(i) extracting a subset of components from the completion of the training example using a rule-based process, wherein the subset of components comprises script types, modules, methods, and entry points of the target programming language;
(ii) extracting API documentation related to the script types, the modules, the methods, and the entry points from the documentation dataset; and
(iii) filtering, by a generative model, the extracted subset of components and the extracted documentation to select one or more relevant methods, from the methods and the role descriptions of the selected one or more relevant modules,
wherein each of the augmented training examples comprises: (i) an augmented prompt including the instructions to generate, before generating a predicted code solution to the code task, a description of the selected one or more relevant modules and the code task to be performed using the target programming language, and (ii) an augmented completion including: the selected one or more relevant modules, role descriptions of the selected one or more relevant modules, and the gold code solution.

14. The system of claim 8, wherein the operations further comprise:
receiving an input from a user, the input comprising a natural language component;
converting the input into a prompt, wherein the prompt comprises an instruction, a code snippet associated with the natural language component, and an utterance associated with the natural language component, and wherein the utterance includes a request to perform the code task using or based on the target programming language;
transmitting the prompt to the fine-tuned machine learning model;
receiving, from the fine-tuned machine learning model, a predicted code solution corresponding to execution of the code task based at least in part on the prompt; and
providing the predicted code solution to the user.

15. One or more non-transitory computer-readable media storing instructions which, when executed by one or more processors, cause the one or more processors to perform operations comprising:
generating, by a generative model based on training examples and a documentation dataset, augmented training examples, wherein:
each of the training examples comprises: (i) a prompt including a code task to be performed using a target programming language, and (ii) a completion including a gold code solution associated with performance of the code task,
the documentation dataset comprises references for components of the target programming language, and
each of the augmented training examples comprises: (i) an augmented prompt including instructions to generate a description of one or more of the components of the target programming language and the code task to be performed using the target programming language, and (ii) an augmented completion including: the one or more components of the target programming language, role descriptions of the one or more components that are extracted directly from the documentation dataset, and the gold code solution; and
fine-tuning a pre-trained machine learning model with at least the training examples and the augmented training examples to generate a fine-tuned machine learning model.

16. The one or more non-transitory computer-readable media of claim 15, wherein the operations further comprise:
generating, by a generative model and/or a structured programmatic process based on the documentation dataset, synthetic training examples, wherein each of the synthetic training examples comprises: (i) a synthetic prompt including a question associated with one or more of the components of the target programming language, and (ii) a synthetic completion including an answer to the question that is extracted directly from the documentation dataset; and
wherein the fine-tuning the pre-trained machine learning model is performed with at least the training examples, the augmented training examples, and the synthetic training examples to generate the fine-tuned machine learning model.

17. The one or more non-transitory computer-readable media of claim 15, wherein the operations further comprise, for each training example in the training examples extracting, by a generative model, the one or more components of the target programming language from a subset of components from the completion of the training example and the role descriptions of the one or more components from the documentation dataset.

18. The one or more non-transitory computer-readable media of claim 15, wherein the operations further comprise, for each training example in the training examples:
(i) extracting a subset of components from the completion of the training example using a rule-based process;
(ii) extracting documentation related to the extracted subset of components from the documentation dataset; and
(iii) filtering, by a generative model, the extracted subset of components and the extracted documentation to extract the one or more components of the target programming language and the role descriptions of the one or more components.

19. The one or more non-transitory computer-readable media of claim 15, wherein the operations further comprise, for each training example in the training examples:
(i) extracting a subset of components from the completion of the training example using a rule-based process, wherein the subset of components comprises script types, modules, methods, and entry points of the target programming language;
(ii) extracting API documentation related to the script types, the modules, the methods, and the entry points from the documentation dataset; and
(iii) filtering, by a generative model, the extracted subset of components and the extracted documentation to select relevant script types, modules, methods, entry points, or any combination thereof from the script types, the modules, the methods, and the entry points and the role descriptions of the selected relevant script types, the selected relevant modules, the selected relevant methods, the selected relevant entry points, or the selected any combination thereof,
wherein each of the augmented training examples comprises: (i) an augmented prompt including the instructions to generate, before generating a predicted code solution to the code task, a description of the selected relevant script types, the selected relevant modules, the selected relevant methods, the selected relevant entry points, or the selected any combination thereof and the code task to be performed using the target programming language, and (ii) an augmented completion including: the selected relevant script types, the selected relevant modules, the selected relevant methods, the selected relevant entry points, or the selected any combination thereof, role descriptions of the selected relevant script types, the selected relevant modules, the selected relevant methods, the selected relevant entry points, or the selected any combination thereof, and the gold code solution.

20. The one or more non-transitory computer-readable media of claim 15, wherein the operations further comprise, for each training example in the training examples:
(i) extracting a subset of components from the completion of the training example using a rule-based process, wherein the subset of components comprises script types, modules, methods, and entry points of the target programming language;
(ii) extracting API documentation related to the script types, the modules, the methods, and the entry points from the documentation dataset; and
(iii) filtering, by a generative model, the extracted subset of components and the extracted documentation to select one or more relevant methods, from the methods and the role descriptions of the selected one or more relevant modules,
wherein each of the augmented training examples comprises: (i) an augmented prompt including the instructions to generate, before generating a predicted code solution to the code task, a description of the selected one or more relevant modules and the code task to be performed using the target programming language, and (ii) an augmented completion including: the selected one or more relevant modules, role descriptions of the selected one or more relevant modules, and the gold code solution.
